(19) United States
(12) Patent Application Publication
(10) Pub. No.: US 2016/0171489 A1
(43) Pub. Date: Jun. 16, 2016

(54) METHOD AND SYSTEM FOR PROMOTIONAL OFFERS EXCHANGE

(71) Applicant: IPROPHET TECHNOLOGY LIMITED, Hong Kong (HK)

(72) Inventors: Jason Felix Tsz-Kiu Chiu, Hong Kong (CN); Donald Kam-Chuen Chan, Hong Kong (HK); Tak-Ko Chan, Hong Kong (CN)

(73) Assignee: IPROPHET TECHNOLOGY LIMITED

(21) Appl. No.: 14/966,822

(22) Filed: Dec. 11, 2015

(30) Foreign Application Priority Data
Dec. 11, 2014 (CN) CN 201410766537.9

(51) Int. Cl. G06Q 20/38; G06Q 20/12; G06Q 30/02

(52) U.S. Cl. CPC G06Q 20/387; G06Q 30/0225; G06Q 20/123

(57) ABSTRACT

A method for exchanging promotional offers and an exchange system are provided. In an embodiment, the method includes receiving an exchange request of exchanging promotional offers for products. Information about the promotional offers is retrieved. Optionally the values of promotional offers from a variety of sources are converted into a single value and/or currency. In an embodiment, the exchange request is verified. Upon successful verification, the promotional offers are deducted, and the exchange transaction of the products are processed. Optionally other payment methods may be used in combination with the promotional offers and/or when the promotional offers are insufficient for purchasing the product desired.

### CROSS-REFERENCE TO RELATED APPLICATIONS

This application claims priority benefit of Chinese Patent Application Number CN201410766537.9 (Docket # BL-1-17), entitled “SYSTEM FOR POINT EXCHANGE AND METHOD THEREOF,” filed on Dec. 11, 2014, by Jason Felix Tsz-Kiu Chiu, Donald Kam-Chuen Chan, and Tak-Ko Chan, which is incorporated herein by reference.

### FIELD

The present specification relates to electronic promotional offers.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Credit card companies provide reward programs in which a user may earn promotional offers (e.g., promotional points) when the user uses the credit card to make payments and/or purchases. Airlines may also provide promotional programs in which the user may accumulate mileage that the user has flight, which mileage may then be converted to promotional points. The reward programs provide options for the user to redeem the accumulated promotional offers for product, credits, and/or air tickets. However, the current reward programs only allow the user to use the promotional offers to pay for items that are listed on the website of the reward programs. The user is not able to use a mobile device to exchange the promotional offers/points for product in an online store and/or a play store.

As can be seen from the above, the current techniques have inconveniencies and deficiencies in practical applications, and it may be desirable to make an improvement.

### SUMMARY

In view of the above deficiencies, in an embodiment a method and a system are provided for exchanging promotional offers for product, service, and/or software applications.

In at least one embodiment, the system includes at least a purchase terminal which may be operated by a user to browse an online store or website, for example, and select product that may be purchased by redeeming promotional offers in the user's account in a promotional offers account system. The purchase terminal is adapted (e.g., hardwired, configured, and/or programmed) to send an exchange request to a promotional offers server.

In at least one embodiment, the system includes at least a purchase terminal that is adapted (e.g., hardwired, configured, and/or programmed) to, in response to the exchange request, query the promotional offers account system for information of promotional offers and/or currencies in the user' account. The promotional offers server is adapted (e.g., hardwired, configured, and/or programmed) to verify the validity of the exchange request by determining whether the promotional offers and/or currencies of the user are sufficient to pay for the selected product. In an embodiment, the promotional offers server is adapted (e.g., hardwired, configured, and/or programmed) to calculate and convert promotional offers to transaction currency and/or virtual currency. If the exchange request is valid, the promotional offers server is adapted (e.g., hardwired, configured, and/or programmed) to instruct the promotional offers account system to deduct the promotional offers and/or currencies that are required to make the exchange. After receiving a confirmation of deduction from the promotional offers account system, the promotional offers is adapted (e.g., hardwired, configured, and/or programmed) to send a request to the store to process the order. If the exchange request is invalid, the promotional offers server is adapted (e.g., hardwired, configured, and/or programmed) to send a notice of invalid request to the purchase terminal and/or provide options of other payment methods.

In at least one embodiment, the system also includes at least a promotional offers account system that is adapted (e.g., hardwired, configured, and/or programmed) to store and manage information of promotional offers programs and/or accounts, and/or currencies in online payment accounts (e.g., using electronic payment methods) of at least one user.

In at least one embodiment, the system also includes at least an online store, mobile application(app) store, and/or website of a store, which is adapted (e.g., hardwired, configured, and/or programmed) to provide electronic product and/or non-electronic product with prices and/or exchange information. Upon receiving the confirmation of successful redemption from the promotional offers server, the store is adapted (e.g., hardwired, configured, and/or programmed) to process the purchase/order.

Throughout this specification, the terms “point,” “promotional offer,” “electronic promotional offer,” and “reward” may be substituted one for the other to obtain different embodiments. Throughout this specification, the terms “exchange” and “redeem” may be substituted one for the other to obtain different embodiments. Throughout this specification, the terms “online store,” “play store,” “store,” “website,” and “provider” may be substituted one for the other to obtain different embodiments. Throughout this specification, the terms “user,” “purchaser,” “customer,” and “person” may be substituted one for the other to obtain different embodiments.

Any of the above embodiments may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1A is a block diagram of an embodiment of a promotional offers exchange system;

FIG. 1B shows a block diagram of another embodiment of the exchange system of FIG. 1A;

FIG. 2A shows a block diagram of an embodiment of the store of FIG. 1A;

FIG. 2B shows a block diagram of an embodiment of the promotional offers account system of FIG. 1A;

FIG. 2C shows a block diagram of an embodiment of the purchase terminal of FIG. 1A;

FIG. 2D shows a block diagram of an embodiment of the promotional offers server of FIG. 1A;

FIG. 3A shows a block diagram of another embodiment of the exchange system of FIG. 1A;

FIG. 3B shows a block diagram of an embodiment of the exchange system of FIG. 3A with options of other payment methods;

FIG. 4 shows a view of an embodiment of the program interface of FIG. 2C;

FIGS. 5A and 5B are flowcharts of an embodiment of a method of exchanging promotional offers for product;

FIG. 6 is a flowchart of an embodiment of a method of verifying the exchange request;

FIG. 7 shows a block diagram of an embodiment of a computer system that may be used as the store, the promotional offers server, and/or the promotional offers account system used in the exchange system; and

FIG. 8 shows a block diagram of an embodiment of the purchase terminal used in the exchange system.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

In various places in discussing the drawings a range of letters, such as a-n or a-c are used to refer to individual elements of various series of elements that are the same. In each of these series, the ending letters are integer variables that can be any number. Unless indicated otherwise, the number of elements in each of these series is unrelated to the number of elements in others of these series. Specifically, even though one letter (e.g. “n”) comes earlier in the alphabet than another letter (e.g., “c”), the order of these letters in the alphabet does not mean that the earlier letter represents a smaller number. The value of the earlier letter is unrelated to the later letter, and may represent a value that is greater the same or less than the later letter.

It should be understood that specific embodiments described herein are only used to explain at least one embodiment but not used to limit the present invention.

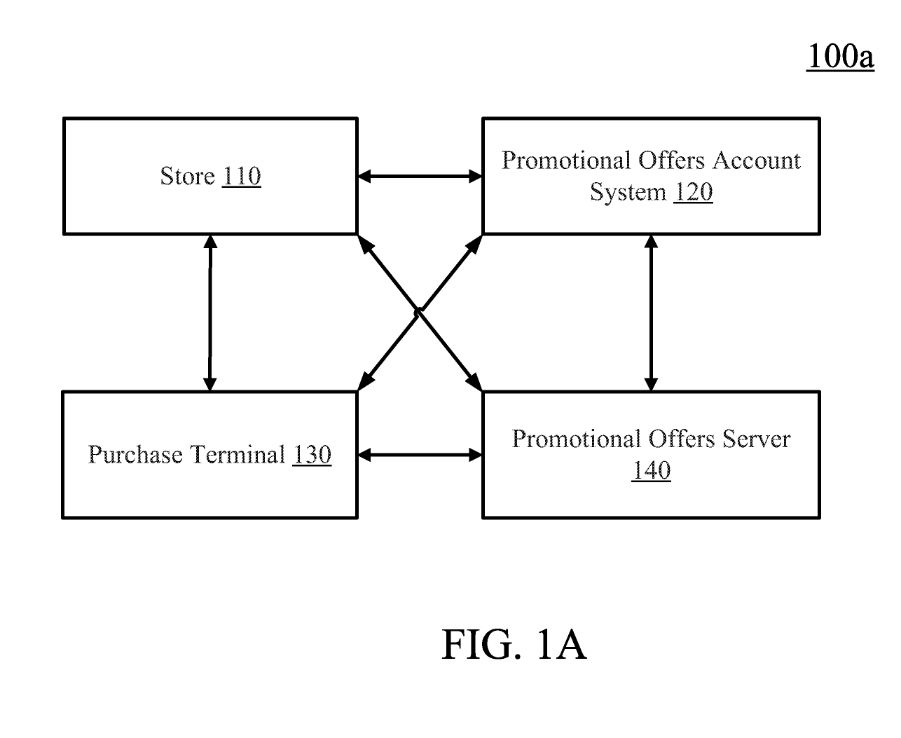

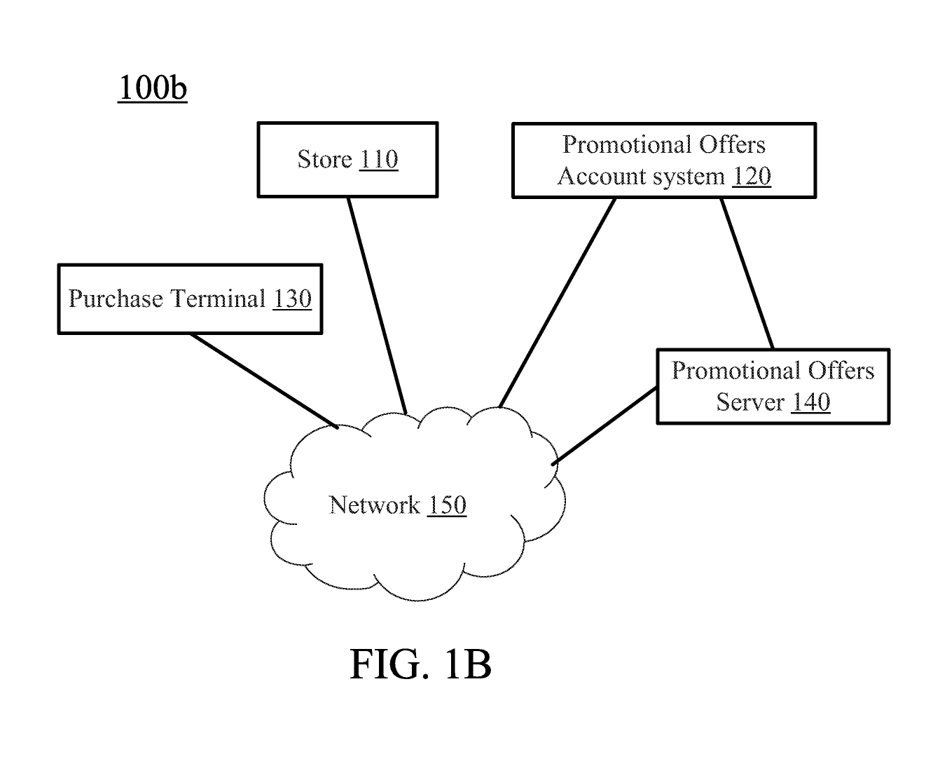

In general, at the beginning of the discussion of each of FIGS. 1-4 and 7-8 is a brief description of each element, which may have no more than the name of each of the elements in the particular figure that is being discussed. After the brief description of each element, each element of FIGS. 1-4 and 7-8 is further discussed in numerical order. In general, each of FIGS. 1-4 and 7-8 is discussed in numerical order, and the elements within FIGS. 1-4 and 7-8 are also usually discussed in numerical order to facilitate easily locating the discussion of a particular element. Nonetheless, there is not necessarily any one location where all of the information of any element of FIGS. 1-8 is located. Unique information about any particular element or any other aspect of any of FIGS. 1-8 may be found in, or implied by, any part of the specification.

FIG. 1A illustrates a block diagram of an embodiment of a promotional offers exchange system 100a. The promotional offers exchange system 100a includes at least a store 110, a promotional offers account system 120, a purchase terminal 130, and a promotional offers server 140. In other embodiments, the exchange system 100a may not have all of the elements or features listed and/or may have other elements or features instead of, or in addition to, those listed.

Promotional offers exchange system 100a provides a system for a user to exchange promotional offers and/or online payment currencies in the user's accounts for products selected from at least one store. In at least one embodiment, the promotional offers include, but are not limited to, promotional offer points, mileages, promotional offer incentives, coupons, promotional offering stamps, discount promotional offers, purchase credits, promotions, cash vouchers, and/or gift tokens, for example. In an embodiment, the promotional offers may include tokens, digital currencies that are Internet based medium of exchange (e.g., Bitcoins), and/or virtual currencies that are used in virtual communities (e.g., QQ coins, Amazon coins). In an embodiment, different promotional offers programs may use different units of promotional offers (e.g., points, scores, virtual currencies, mileage, coupons, credits, etc.), while different promotional offers program may have different terms and/or exchange rules for redeeming the promotional offers.

Store 110 may include an electronic product store (e.g., which sells downloadable electronic products), an online shopping website, a play store on mobile devices (e.g., Google Play store, Apple App store, BlackBerry OS App Stores, etc.), a store for purchasing applications, a game store, a website of a physical store, and/or a physical store that may have one or more retail terminals. In this specification, the electronic products are used as an example, because downloadable products are convenient to purchase by the disclosed system, but electronic products are only an example. Any type of product may be sold by store 110, and store 110 may be brick and mortar store and/or an online store. In at least one embodiment, the store 110 serves as a provider that provides/sells electronic products and/or non-electronic products. In at least one embodiment, store 110 may sell electronic product such as software, applications (apps) for mobile devices, game apps, games, multimedia, online music, online movies, and/or electronic books (e-books). In an embodiment, store 110 may sell non-electronic products, such as physical products and/or services. Throughout this specification, the terms “product,” “products,” “items,” and “orders” are used interchangeably, and may be substituted one for the other to obtain different embodiments. In at least one embodiment, store 110 communicates with a promotional offers server for transmitting information about products, such as sales and prices related to the products and/or the exchange value of the product. In an embodiment, the exchange value of product shows the value/amount of promotional offers that are required to make an exchange for the product.

In one embodiment, the store 110 may accept payments in national currencies of any of a variety of countries, other currencies in circulation (circulating currencies), digital currencies, virtual currencies, and/or online payments. Alternatively or additionally, promotional offers may be exchanged for part or all of the payment of a product. In an embodiment, circulating currencies include currencies that are in common use in a region (e.g., can be used in transactions in physical world and online, such as US dollar, RMB, Singapore dollar, etc.). Online payments may include electronic payment methods implemented during online shopping and/or online transaction (e.g., using credit/debit card information, bank account information, PayPal®, Google Wallet®, Chase quick pay, etc.). The online payments may be made in one or more currencies in circulation (e.g., payments may be made in US dollars from a user's PayPal account). In an embodiment, when online payments are used for purchases, information about the online payment account is provided that may include a user account identity (ID or user name) and/or a personal e-mail address. As a result of only needing to provide payment account information, online payment is more convenient compared to making payments using cash, check, and/or money transfer.

Promotional offers account system 120 is a system that is configured (e.g., hardwired and/or programmed) to store and/or manage promotional offers accounts and/or online payment accounts of at least one purchaser. In at least one embodiment, the promotional offers account system 120 manages various promotional offers programs, and a user may access various promotional offers accounts associated with various promotional offers programs. In an embodiment, the user may log into one user account that allows the user to access and/or manage various promotional offers associated with various programs. In at least one embodiment, the users may also manage the online payment accounts in the promotional offers account system 120 (e.g., to pay by online payment funds for product). In at least one embodiment, the promotional offers account system 120 communicates with the promotional offers server to provide information about the promotional offers and/or online payment accounts of the user upon request. The promotional offers account system 120 may also communicate with the store 110 to obtain exchange values of product and/or purchase information. In an embodiment, the promotional offers account system 120 may record promotional offers earned based on purchases made in the store 110. Throughout this specification, the terms “promotional offers program,” “promotional program,” “reward program,” and “point program” are used interchangeably, and may be substituted one for the other to obtain different embodiments.

In at least one embodiment, the promotional offers account system 120 may be installed outside the promotional offers server, while the user's login data of the promotional offers accounts (e.g., user identity, pass code, etc.) is not stored and/or processed by the promotional offers server. Alternatively, the promotional offers account system 120 may be part of the promotional offers server, while the promotional offers account system 120 may include programs and/or databases installed in and/or running on the promotional offers server.

Purchase terminal 130 is a terminal that may be used by a user to make purchases of products from the store 110. In at least one embodiment, the purchase terminal 130 is a computing device and/or network appliance that is used by the user to access, via a network, a website of the store 110, an app store, a shopping website, and/or to use software applications to do online shopping and/or transactions. In an embodiment, the purchase terminal 130 is a mobile device that may be used and/or owned by a user for browsing and selecting product, and/or receiving, storing, tracking, managing and/or redeeming promotional offers. For example, the purchase terminal 130 may include smart phones, PDA (Personal Digital Assistant), tablet PCs, laptops, game devices, and/or other electronic mobile devices. In an embodiment, the purchase terminal 130 may be installed with mobile operating systems (OS) such as, but are not limited to, Apple iOS, Google Android, Research in Motion's BlackBerry OS, Nokia's Symbian, Hewlett-Packard's webOS (formerly Palm OS), and Microsoft's Windows Phone OS. The purchase terminal 130 may also have other uses, such as making phone calls, browsing a network, personal computing, and/or receiving messages. In another embodiment, the purchase terminal 130 may be a desktop computer with Android or other operating systems. In yet another embodiment, the purchase terminal 130 may be a SmartTV or Set-top box connecting with a TV set with Linux or Android OS or the like. In at least one embodiment, the purchase terminal 130 is communicatively connected to the promotional offers account system 120 for accessing the user's promotional offers accounts and/or online payment accounts. The purchase terminal 130 also communicates with the promotional offers server, to send exchange requests for exchanging promotional offers for products, and to receive results information of exchanges (e.g., success of exchange, notice of invalid request, options of other payment methods, etc.). In an embodiment, the purchase terminal 130 includes a program interface, via which the purchased electronic product may be downloaded and/or accessed using a link and/or a code transmitted by the store 110 and/or the promotional offers server.

In at least one embodiment, the purchase terminal 130 may be connected to the promotional offers server using a web browser on the purchase terminal 130 or via online shopping Apps that are pre-installed in the purchase terminal 130. In an embodiment, the purchase terminal 130 may log into a user account in the promotional offers account system 120 via a web browser or a program interface of an online shopping App. In at least one embodiment, the connection between the purchase terminal 130 and the promotional offers account system 120 is secured and/or encrypted. In an embodiment, the connection between the purchase terminal 130 and the promotional offers server is also secured and/or encrypted.

Promotional offers server 140 is a server that manages and tracks information about the users, promotional offers, payment accounts, and/or product, and verifies and processes exchange of promotional offers for product. In at least one embodiment, the promotional offers server 140 receives the exchange request sent by the purchase terminal 130, queries the promotional offers account information and/or online payment account information of the user in the promotional offers account system 120, and verifies if the exchange request is valid. If the promotional offers of the user and/or online payment currencies of the user are sufficient to pay for the product, the exchange request is considered valid and the promotional offers server 140 sends instructions to the promotional offers account system 120 to deduct the corresponding promotional offers and/or currencies. After receiving a confirmation of deduction from the promotional offers account system 120, the promotional offers server 140 sends to the store 110 a request to process the order. If the promotional offers of the user and/or online payment currencies of the user are insufficient to pay for the product, the exchange request is considered invalid and the promotional offers server 140 sends to the purchase terminal 130a a notice of invalid request, and/or a message with other payment options for the user to pay using other payment methods.

In an example, the store 110 displays product that may be purchased by redeeming promotional offers and/or via online payment methods. A user may use the purchase terminal 130 to browse the store website, shopping website, and/or mobile App store, and then, via terminal 130, select a product. The user may also use the purchase terminal 130 to access the promotional offers accounts in the promotional offers account system 120 to pay for the selected product. Then the purchase terminal 130 sends an exchange request to the promotional offers server 140 for redeeming the promotional offers and/or currencies in the user's account for the selected product in the store 110. The promotional offers server 140 receives the exchange request and queries information about the user's promotional offers accounts and/or online payment accounts in the promotional offers account system 120, and stores the information received from the promotional offers account system 120. The promotional offers server 140 may convert the promotional offers to a value of a currency used internally within the system to settle the account (which may be referred to as an internal settlement currency or an internal currency). The promotional offers server 140 then verifies whether the exchange request from the purchase terminal 130 is valid, for example, by verifying the validity of the user's accounts and determining whether the promotional offers are sufficient to pay for the selected product (e.g., the promotional offers terminal may check whether there is a gap between the price of the product and the value of the promotional offers). If the user's promotional offers are not sufficient, the promotional offers server 140 may further verify whether the user's online payment account(s) has a sufficient remaining balance to fill in the gap. If the promotional offers server 140 determines that the user's promotional offers and/or the remaining balance in the online payment account are sufficient to pay for the selected product, the exchange request is considered valid, and the promotional offers server 140 requests the promotional offers account system 120 to deduct the corresponding promotional offers and/or the value of currencies in the user accounts. The promotional offers server 140, after receiving a confirmation of the deduction from the promotional offers account system 120, sends a request to the store 110, which accordingly processes the transaction and/or the order so that the selected products are available to the user. The promotional offers server 140 and/or the store 110 may send to the purchase terminal 130 a confirmation that the exchange is successful, and/or may send instructions for how to obtain the product (e.g., a download link, a code, pickup token/voucher, delivery tracking information, etc.). If the promotional offers and/or currency value of the user are insufficient to pay for the product, the exchange request is deemed invalid, and the promotional offers server 140 returns a notice of invalid request to the purchase terminal 130. The promotional offers server 140 may also send information about the invalid request to the purchase terminal 130 (e.g., the information may indicate that there request was invalid because the request included an invalid promotional offers account or that the user had insufficient promotional offers and/or currencies to pay for the product, etc.). The promotional offers server 140 may also send options of other payment methods to the purchase terminal 130 for the user to select to pay by other payment methods.

In an embodiment, the user's promotional offers may be used to pay for electronic products in electronic product store (e.g., a mobile App store) via a mobile device. The electronic product, upon completion of the exchange, would be available for downloading (e.g., e-books, Apps, multimedia content, etc.) and/or ready to be activated/installed on the mobile device, which may include installing an upgrade to a product that the user already has (e.g., the game equipment and/or roles that are redeemed using the promotional offers would be available for activation/use in virtual games upon completion of the exchange). In an embodiment, the electronic product or downloading instructions would be sent by the electronic product store to the purchase terminal 130 or an email address of the user. Alternatively or additionally, the download link and/or codes may be sent to an email address provided by the user (e.g., the download link may be sent to an email address of a friend of the user if the user purchases the electronic product as a gift).

In an embodiment, the exchange system 100a may use the promotional offers as a payment method for non-electronic product in shopping websites and/or in the websites of physical stores. The store 110 or a supplier (e.g., a supplier that supplies the store 110), upon receiving the request for processing the order from the promotional offers server 140, prepares the product for delivery or for pickup (in the case of the supplier, the supplier may receive the request from store 110, and the request received by the supplier maybe a request or based on a request received by the store received from the purchaser, via purchase terminal 130). In an embodiment, the promotional offers server 140 may send an electronic token, coupon, or voucher which is used by the user (or another person) to pick up the corresponding product.

As another example, promotions offer server 140 may determine a plurality of combinations of promotional offers and/or other methods of payments, where each of the plurality of combinations of promotional offers and/or other methods of payments is sufficient to pay for the product. The promotions offer server 140 may send to the purchase terminal 130, a list of the plurality of combinations of promotional offers and/or other payment methods. Then the promotions offer server 140 may receive from the purchase terminal 130, a selection of one combination from the plurality of combinations of promotional offers. Then a request may be sent from the promotional offers server 140 to the promotional offers account system 120 to deduct the selected one combination of promotional offers from the user's account.

FIG. 1B illustrates a block diagram of another embodiment of the exchange system 100a of FIG. 1A. Exchange system 100b includes at least store 110, promotional offers account system 120, purchase terminal 130, and promotional offers server 140, which were discussed in conjunction with FIG. 1A. Exchange system 100b also includes a network 150. In other embodiments, the exchange system 100b may not have all of the elements or features listed and/or may have other elements or features instead of, or in addition to, those listed.

FIG. 1B shows that the exchange system 100b includes a network via which the store 110, promotional offers account system 120, purchase terminal 130, and promotional offers server 140 may communicate with one another.

Network 150 may be any combination of local area networks, wide area networks (e.g., the Internet), wireless phone networks and/or ordinary phone networks. For example, network 150 may be a local network that is run by store 110. As another example network 150 maybe a combination of a mobile phone network (servicing purchase terminal 130) and the Internet, which purchase terminal 130 accesses, via the mobile phone network. As another example, network 150 may be combination of a local network that is run by store 110, a mobile phone network, and the Internet, and there may be one router to which promotional offers account system 120 and promotional offers server 140 access the internet, while promotional offers account system 120 and promotional offers server 140 may communicate with each other, via local network.

The purchase terminal 130 may access user accounts in the promotional offers account system 120 via the network 150. The purchase terminal 130 may communicate with the promotional offers server 140 to redeem/exchange the promotional offers for product and/or pay for product using online payment accounts. The purchase terminal 130 may browse the online store or website of the store via network 150. In at least one embodiment, the promotional offers server 140 may communicate with the promotional offers account system 120 via network 150 to obtain promotional offers information and verify an exchange request. In an embodiment, the promotional offers account system 120 may be part of the promotional offers server 140, while the promotional offers server 140 may communicate directly with the promotional offers account system 120 (e.g., via wires). The promotional offers server 140 may communicate with the store 110, via the network 150, to obtain prices and/or exchange values of product and/or to adjust prices and/or exchange values.

Promotional offers server 140 may use algorithms and/or Application Programming Interfaces (APIs) to provide exchange system 100 with the ability to access and keep track of possible sources of funding for the user's purchases across a plurality of different accounts and account types, and to determine the amount funds that would be required, in a particular type of funding, to facilitate a purchase using a different funding type

The APIs of promotional offers server 140 facilitate a software-to-software (i.e. server-to-server) interface for accessing and searching each of the user's accounts for items of value belonging to the user. In the specification, the term “item of value” may refer to points, credits, rewards, units of a currency, virtual objects, or any other item that may be owned and traded in transactions made via a network of inter-connected computing devices.

The algorithms and/or APIs of promotional offers server 140 may use an identifier associated with a user, such as an e-mail address or user name, to perform lookups of information about accounts belonging to the user at least one provider of goods or services.

In an embodiment, the algorithms and/or APIs of promotional offers server 140 may further look up and apply preexisting server-to-server policies or methodologies for interacting directly with accounts held by a user at various stores, financial institutions, game servers or virtual financial markets. An initial step may be performed to obtain information from a user for accessing the accounts of the user, and afterwards promotional offers server 140 may access the accounts of the user without direct involvement from the user.

In an alternate or complementary embodiment, when no formal policy or API exists for accessing a user account with a particular service provider, promotional offers server 140 may determine the steps required access the accounts of a particular institution and give the user an option to provide the information required in each step, in order to grant promotional offers server 140 the ability to access the accounts in the future, on the user's behalf, without further interaction on the part of the user.

The user information provided to exchange system 100 may include user credentials, pins, and/or answers to questions for allowing exchange server 100 to authenticate, via server-to-server interface, with the providers of the external accounts owned by the user.

Based on the steps required to gain access to a particular service provider, promotional offers server 140 may store a custom policy or API to apply when interacting with the server of that particular service provider in the future.

Promotional offers server 140 may regularly access the user's accounts with different service providers to retrieve information about the user's items of value, such as credit card reward points, department store points, digital items held in the user's inventory in an online game account, items listed for sale by the user in a user's account at online store, and so on.

When accessing an account of the user, promotional offers server 140 may use the algorithms of exchange system 100 log into a first account of the user that is associated with the store or other service provider the user would like to purchase from, and a second account of the user having the items of value the user would like to trade or sell in order to fund the purchase. In this embodiment, exchange server 100 acts as an agent of the user to perform and confirm transactions on behalf of the user to trade items of value in one marketplace to fund purchases in a second marketplace. For example, exchange server 100 may obtain funds by converting the gift cards of a local store in a particular region into a currency of the region of origin, then use a traditional currency exchange marketplace to convert the currency of origin into the currency of a different region, within which the user is traveling, and finally, using the resulting funds to purchase an item in the region within which the user is traveling.

Additionally, the currency exchange system includes algorithms, i.e., modules, and/or Application Programming Interfaces for obtaining and tracking information related to currency performance and usage data and items, points traded in those currencies historically.

In an embodiment, promotional offers account system 120 may or may not be part of promotional offers server 140, and information about the user and promotions may be shared between promotional offers account system 120 and promotional offers server 140.

As mentioned above, in an embodiment, a client side interface, such as purchase terminal 130, is provided to the device of a user for entering a user identifier. The identifier is sent from the user device to a server having a system for performing currency exchanges, such as promotional offers server 140.

Promotional offers server 140 determines the pre-conversion and after conversion value of the user's items of value, as described below. Any of the steps performed by promotional offers server 140 may make use of one or more APIs of exchange system 100 for interacting with external systems having accounts associated with the users of exchange system 100.

In step 1, the value of an item of value within a “native marketplace” is determined by the promotional offers server 140. The native marketplace is the marketplace of origin of the item of value. For example, 10 rewards points in a user's account at major department store may have a one-to-one correspondence to units of the national currency, in the country the store is located; e.g., 10 rewards points may equal 10 U.S. dollars when used in New York, at the department store that issued the points—i.e., “the native market place” of the 10 rewards points. In another example, the crafting material “Platinum Materia” may cost 3.5 million “GIL” at an auction house in the digital game world of Fatal Fantasy, due to rarity of the item within that virtual world, and the ability of that item the create powerful weapons, which are not obtainable by any other method.

In step 2, the promotional offers server 140 runs an algorithm for selecting a first currency, which is not the native currency of the item of value, to use as a baseline exchange currency. The baseline exchange currency may be a currency that is in widespread use and, as a result, is easier to use as a baseline for determining the item's value in a plurality of other currencies that are not the baseline currency or the native currency of the item.

Alternatively, the baseline currency may be the currency that has been, historically, used most often when a particular item of value was sold across currencies in the past. In this alternative embodiment, the baseline currency is determined by an algorithm on the server that acquires information about prior cross currency transactions related to the item of value.

In step 3, the server runs an algorithm that estimates the current value of the item in the baseline currency, based multiple factors. The factors for estimating the value of the item in the baseline currency may include, (1) the current value of the item in the native marketplace of the item, (2) historical data listing past, cross currency transactions related to the item, (3) the volume of cross currency transactions associated with the item, and (4) the size of the native marketplace relative to the wider marketplace within which exchange system 100 is used.

In step 4, value of the item in the baseline currency is used, by promotional offers server 140, to determine the value of the item in currency of interest to the user. For example, promotional offers server 140 receives a user's request to purchase a sweater at a department store, using 2 pieces of platinum material from Fatal Fantasy. The sweater may be purchased with 100 department store points.

Promotional offers server 140 uses the APIs of exchange system 100 to look up and process data related to value of the department store points, and determines the value of the department store points in the baseline currency selected by promotional offers server 140 (e.g., the U.S. dollar). In this example, the value of the department store points is 0.5 USD (in other words, 2 points in the native currency are equal to 1 dollar in the baseline currency).

Next, promotional offers server 140 uses the APIs of exchange system 100 to look up and process data related to value of platinum material in its native currency, and determines the value of the platinum material in the baseline currency selected by promotional offers server 140 (again, the U.S. dollar). In this example, the value of each piece of platinum material is 3.5 million in its native currency, the GIL. 1 million GIL is equal to 5 USD, and the value of 1 GIL is 0.000005 USD. Accordingly, a single piece of material is equal to 17.5 USD, and two pieces of material are equal to 35 USD. 35 USD, which, in turn, are equal to 70 department store points.

Promotional offers server 140 may determine that a user is not able to complete a transaction, and informs the user of the difference between the value of the items the user would like to exchange, and the amount of the item the user would like to purchase. Server 140 may suggest to the user an action that might be sufficient to complete the purchase, e.g., “Would you like to exchange 3 platinum material for 105 store points?” or “Would you like to pay for the remainder of the purchase using a credit card?”.

In this example, the user chooses to exchange 3 material for store points, the purchase is completed, and the user will now have 5 department store points remaining for use in future transactions (1 material=17.5 USD*3=52.5 USD. 52.5 USD*2=105 department store points. The sweater is purchasable for 100 department store points, and 105−100=5 department store points).

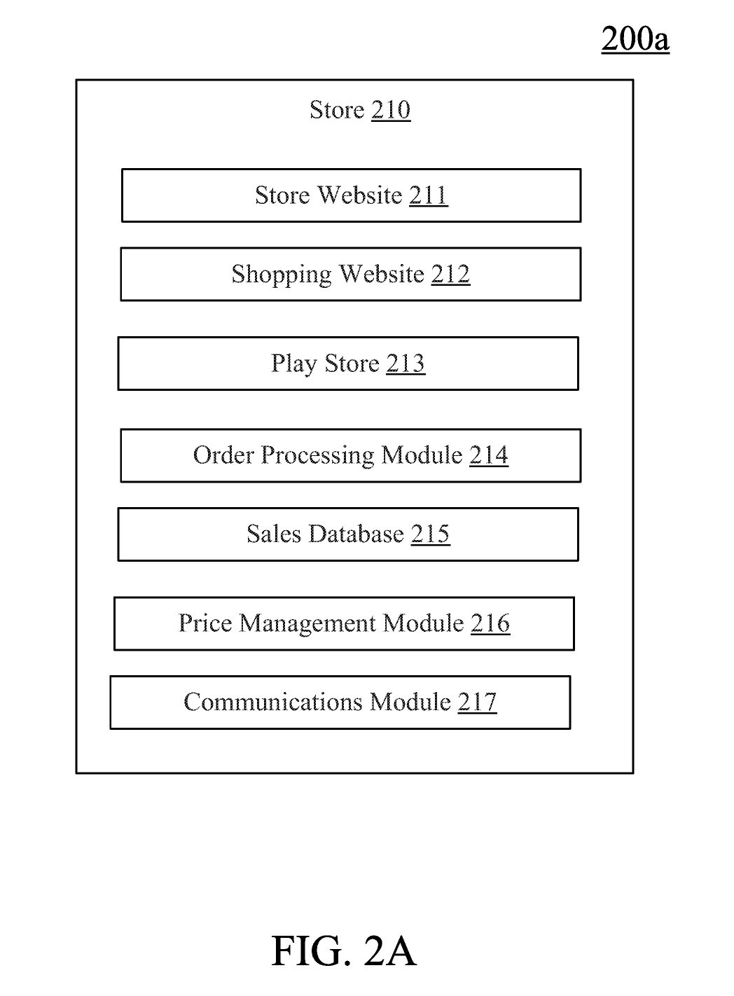

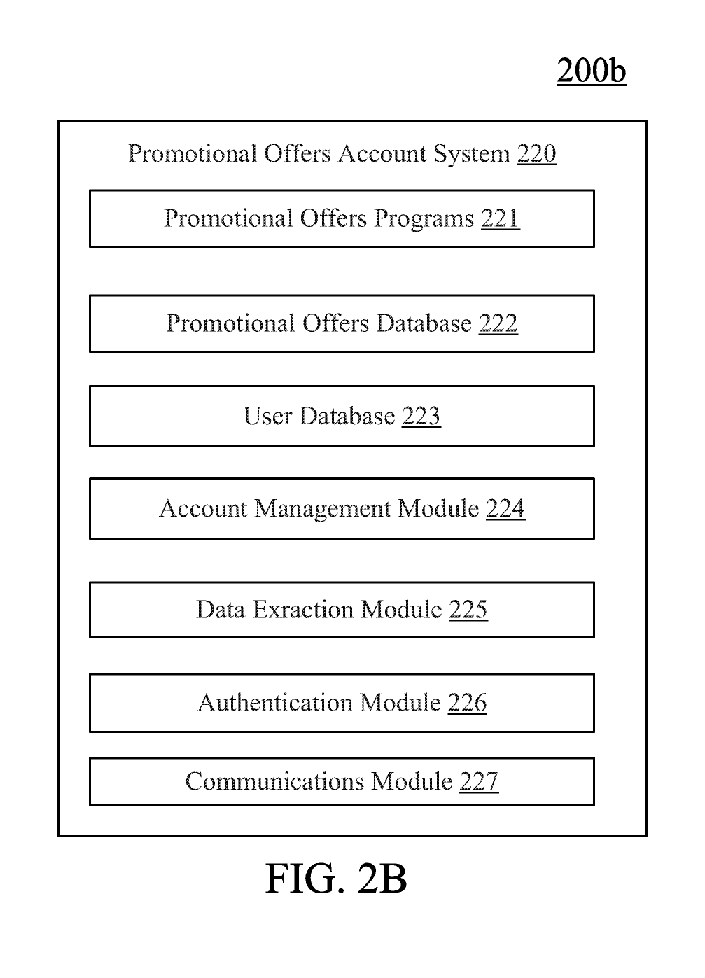

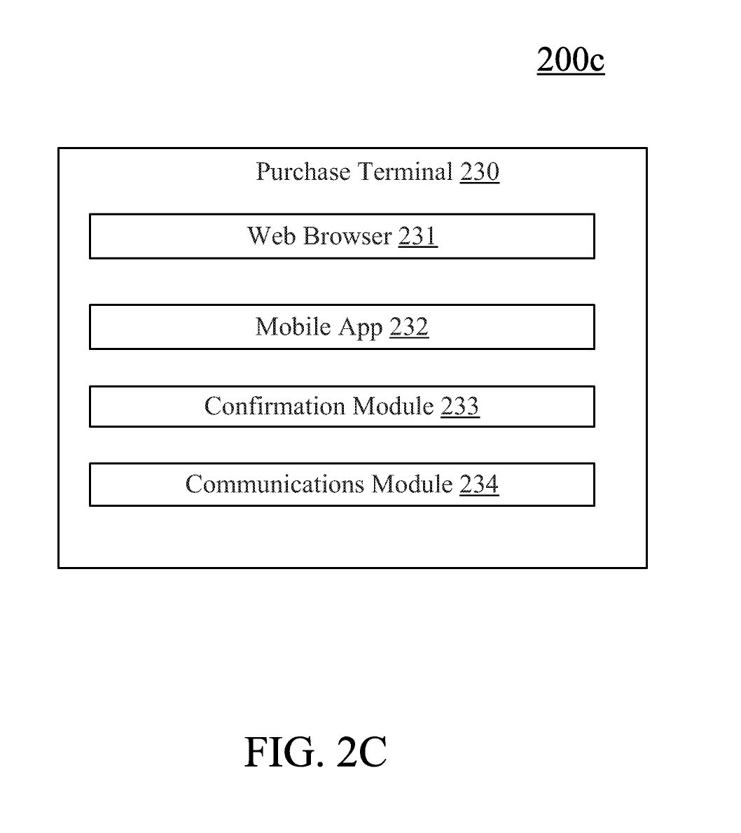

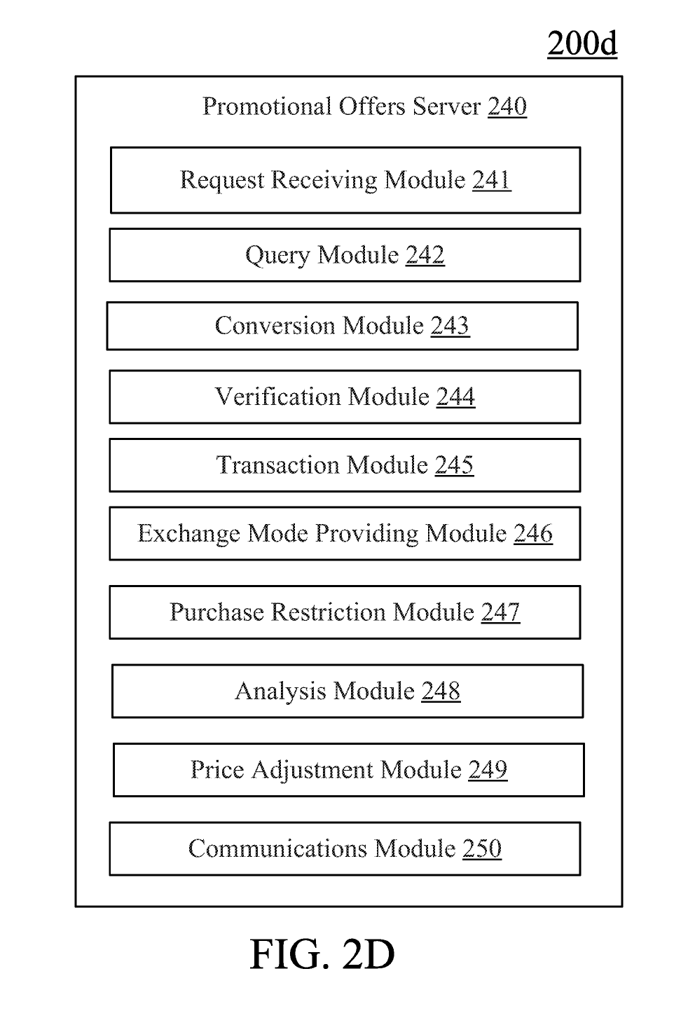

FIG. 2A illustrates a block diagram of an embodiment of the store 110 of FIG. 1A. Store 210 includes at least a store website 211, a shopping website 212, a play store 213, an order processing module 214, a sales database 215, a price management module 216, and a communications module 217. In other embodiments, the store 210 may not have all of the elements or features listed and/or may have other elements or features instead of, or in addition to, those listed.

Store 210 may be an embodiment of the store 110, which was discussed in conjunction with FIG. 1A.

Store website 211 is the website of the store 210 that lists product and/or service provided by the store 210. In an embodiment, a user may browse the store website 211 using the purchase terminal 130.

Shopping website 212 is a website on which a user may shop for product and/or service online. In an embodiment, a user may access the shopping website 212 using a web browser and/or mobile optimized online site or app. In an embodiment, shopping website 212 may list product that are provided by different stores. In an embodiment, a user may browse the store website 211 using the purchase terminal 130. In an embodiment, the store website 211 and/or the shopping website 212 may list information of exchange values of product (e.g., a number of certain promotional offers may be used to redeem for the product) other than prices of the product.

Order processing module 214 is a module that is configured (e.g., hardwired and/or programmed) to process orders and/or complete exchange transactions. In this specification, the term “module” is to be understood as being generic to software, hardware modules, and combinations of software and hardware modules. In an embodiment, if electronic products are purchased using the promotional offers, after receiving a confirmation of the redemption from the promotional offers server 140, the order processing module 214 may transmit download information of (that is, information that was downloaded about) the purchased electronic product to the promotional offers server 140, while the promotional offers server 140 may provide the download information to the purchase terminal 130 and/or an account designated by the user (e.g., an email address or user account of the user or an email address of a friend to whom the user intends to send the purchased product as a gift). Alternatively or additionally, the order processing module 214 may directly transmit the download information to the purchase terminal 130 and/or a user account. For example, the order processing module 214 or the promotional offers server 140 may send a download link with a pass code to the purchase terminal 140 or an email address of a user, while the user may download the corresponding electronic product to the purchase terminal 140 or other computing devices. In another embodiment, the order processing module 214 may communicate with an application, website, and/or software to activate the purchased electronic product for the user to use. For example, if the user redeemed the promotional offers for virtual weapons in a virtual game, the order processing module 214 may communicate with the virtual game application and activate the corresponding virtual weapons in the user account in the virtual game so that the user may start using the virtual weapons. In another embodiment, if the products that are purchased using the promotional offers include physical products, the order processing module 214 may send instructions to a sales terminal in the store 210 or website of the store 210 to inform a store assistant or staff to prepare the product for delivery or pickup. The order processing module 214 may also send a confirmation of delivery, pickup notice or voucher, and/or order processing status to the purchase terminal 130 and/or the email address of the user, for example. The user may also use the purchase terminal 130 to send instructions to the store 110 and/or promotional offers terminal 140 to request the store 110 to deliver the product, via a delivery service company, to a designated address. In another embodiment, if the products that are purchased using the promotional offers include service, the order processing module 214 may send a certificate, voucher, or coupon to the purchase terminal 130 and/or an account designated by the user. The user may use the received certificate, voucher, or coupon to get the service accordingly.

Sales database 215 is a database for storing information regarding the product in the store 210 including, but not limited to, a list of products, sales and/or transactions, inventory of the store 210, prices, exchange values of product, promotions, restrictions and/or rules for price adjustment, etc.

Price management module 216 is a module that is configured (e.g., hardwired and/or programmed) to manage, update, and adjust the prices and/or exchange values of the product and/or service provided by the store 210. In an embodiment, the price management module 216 updates information about the prices of product and/or service in the sales database 215.

Communications module 217 is a module that is configured (e.g., hardwired and/or programmed) to transmit and/or receive signals. In at least one embodiment, the communications module 217 may include at least a transmitter and a receiver. In at least one embodiment, the communications module 217 is adapted (e.g., hardwired, configured, and/or programmed) to communicate via the network 150 with the promotional offers server 140, the purchase terminal 130, and/or the promotional offers account system 120.

FIG. 2B illustrates a block diagram 200b of an embodiment of the promotional offers account system 120 of FIG. 1A. Promotional offers account system 220 includes at least promotional offers programs 221, a promotional offers database 222, a user database 223, an account management module 224, a data extraction module 225, an authentication module 226, and a communications module 227. In other embodiments, the promotional offers account system 220 may not have all of the elements or features listed and/or may have other elements or features instead of, or in addition to, those listed.

Promotional offers account system 220 may be an embodiment of the promotional offers account system 120, which was discussed in conjunction with FIG. 1A.

Promotional offers programs 221 includes a plurality of programs which may be provided and/or managed by different companies, merchant systems, websites, and/or stores. In an embodiment, different companies may provide different promotional offers programs 221 through which users may accumulate different types of promotional offers under different rules. In an embodiment, the promotional offers in the promotional offers programs 221 may be redeemed for a variety of product and/or service.

Promotional offers database 222 is a database for storing information regarding the promotional offers in the promotional offers programs 221 including, but not limited to, information about promotional offers program accounts, various types of promotional offers, values and/or balances in the promotional offers accounts, rules for earning promotional offers, redemption rules and/or conditions, exchange restrictions, and/or redemption history. In an embodiment, the promotional offers database 222 also stores information about the online payment accounts of users. In an embodiment, the promotional offers database 222 also stores conversion rules for converting the promotional offers and/or online payment currencies to values in a currency in circulation, internal settlement currency values, virtual currency values, and/or to another type of promotional offer.

User database 223 is a database that stores personal data of the users including, but not limited to, users' profile, promotional programs associated with the user's profile, purchasing history, browsing history, searching history, personal preferences, habits, posts, clicked advertisements, and/or social circles. In at least one embodiment, the user database 223 provides data for the promotional offers server 140 to analyze the user's personal preference and habits, for example.

Account management module 224 is a module that is configured (e.g., hardwired and/or programmed) to manage, search, sort, adjust, update, edit, delete, and/or extract information including, but not limited to, users' personal information, promotional offers information, and/or online payment information in user accounts in the promotional offers database 222 and/or the user database 223.

Data extraction module 225 is a module that is configured (e.g., hardwired and/or programmed) to extract users' data from the user database 223 and extract promotional offer information and/or online payment account information from the promotional offers database 222. In at least one embodiment, the data extraction module 225 includes algorithms to extract data from the user database 223 and promotional offer information from promotional offers programs 221 and/or promotional offers database 222. In an embodiment, different promotional offers from different programs may have different data contents. For example, an airline frequent flyer program may have promotional offers in the units of mileage with expiry date. The data contents for the airline frequent flyer program in the promotional offer information database 222 may include a plurality of sets of mileages expiring on different future date. In another example, a credit card issuing bank may provide a promotional offers program that issues reward dollars or points without expiry date. The program of the credit card company may have data content (number of reward dollars or points) in the promotional offer information database 222, the content of which may be less than that of an airline mileage program.

Authentication module 226 is a module that is configured (e.g., hardwired and/or programmed) to authenticate user identity when a user intends to access the user account and/or when the promotional offers server 140 queries the promotional offers account system 220 for data about the user's promotional offers. In an embodiment, the authentication module 226 verifies if the user identity and/or pass code sent from the purchase terminal 130 or promotional offers server 140 match the record stored in the promotional offers account system 220. If yes, the authentication is considered successful and the promotional offers account system 220 allows access by the purchase terminal 130 or the promotional offers server 140. If no, the authentication is considered unsuccessful and the promotional offers account system 220 sends a message back to the purchase terminal 130 or the promotional offers server 140 notifying invalid user identity/pass code.

In at least one embodiment, the authentication module 226 stands as the gateway to secure user account information. As shown in FIG. 2B, the authentication module 226 is part of the promotional offers account system 220. In one embodiment, the authentication module 226 stores the encrypted user identify and/or pass code in the authentication module 226, and accepts inputs from the purchase terminal 130. The communication link between the purchase terminal 130 and the promotional offers account system 220 may be encrypted to further protect security of the user identify and pass code. In an embodiment, the authentication module 226 verifies whether the user identify and pass code match the preset record. In an embodiment, the authentication module 226 enforces the pass code policy, including but not limited to usage of characters in the pass code, and requirement to change pass code in a predetermined time and two-way authentication. In an embodiment, the authentication module 226 enforces device policy on responding to incorrect authentication such as non-suggestive response, that is, not to provide feedback to user's attempts to access user account, and number of failed attempts before locking out the user account. When the authentication module 226 has authenticated a correct user identify and pass code, the authentication module 226 allows further access from the purchase terminal 130 to the user database 223 and promotional offers programs 221.

Communications module 227 is a module that is configured (e.g., hardwired and/or programmed) to transmit and/or receive signals. In at least one embodiment, the communications module 227 may include at least a transmitter and a receiver. In at least one embodiment, the communications module 227 is adapted (e.g., hardwired, configured, and/or programmed) to communicate via the network 150 with the promotional offers server 140, the purchase terminal 130, and/or the store 110 and/or 210.

FIG. 2C illustrates a block diagram 200c of an embodiment of the purchase terminal 130 of FIG. 1A. Purchase terminal 230 includes at least a web browser 231, a mobile app 232, a confirmation module 233, and a communications module 234. In other embodiments, the purchase terminal 230 may not have all of the elements or features listed and/or may have other elements or features instead of, or in addition to, those listed.

Purchase terminal 230 may be an embodiment of the purchase terminal 130, which was discussed in conjunction with FIG. 1A.

Web browser 231 is a browser installed in the purchase terminal 230 via which the user may access the internet. In an embodiment, the user uses the web browser 231 to browse websites of stores and/or shopping websites and select product/service to purchase. In an embodiment, the user also uses the web browser 231 to access a user account in the promotional offers account system 120/220 to redeem the promotional offers for the selected product/service, and/or to pay by the online payment currencies in the user account. The web browser 231 may also be used to browse other websites, do searches, and/or to socialize online. In an embodiment, the browsing history, searching history, clicked advertisement, and/or posts online may be tracked and analyzed by the promotional offers server 140.

Mobile app 232 is a mobile application via which the user may access the online stores (e.g., electronic product store, mobile app store), the promotional offers server, and/or the promotional offers account system 120/220. In an embodiment, the mobile app 232 is installed in a mobile device of the user. In an embodiment, the mobile app 232 may be used to select product in the store 110/210, to redeem promotional offers for the product, and/or to use online payment methods to make payments.

Confirmation module 233 is a module that is configured (e.g., hardwired and/or programmed) for receiving confirmation of exchange/payment from the user and sending the confirmation to the promotional offers server 140.

Communications module 234 is a module that is configured (e.g., hardwired and/or programmed) to transmit and/or receive signals. In at least one embodiment, the communications module 234 may include at least a transmitter and a receiver. In at least one embodiment, the communications module 234 is adapted (e.g., hardwired, configured, and/or programmed) to communicate via the network 150 with the promotional offers server 140, the store 120 and/or 220, and/or the promotional offers account system 120 and/or 220.

FIG. 2D illustrates a block diagram 200d of an embodiment of the promotional offers server 140 of FIG. 1A. Promotional offers server 240 includes at least a request receiving module 241, a query module 242, a conversion module 243, a verification module 244, a transaction module 245, an exchange mode module 246, a purchase restriction module 247, an analysis module 248, a price adjustment module 249, and a communications module 250. In other embodiments, the promotional offers server 240 may not have all of the elements or features listed and/or may have other elements or features instead of, or in addition to, those listed.

Request receiving module 241 is a module that is configured (e.g., hardwired and/or programmed) to receive exchange requests sent by the purchase terminals 130 and/or 230. In an embodiment, the request receiving module 241 receives information about the selected product and/or user information, so that the promotional offers server 240 may query the promotional offers account system 120/220 for the information about the promotional offers and/or online payment accounts of the user.

Query module 242 is a module that is configured (e.g., hardwired and/or programmed) to query, based on the exchange request received by the request receiving module 241, the promotional offers account system 120/220 for the user's promotional offers information and/or online payment account information. An example of psuedocode illustrating a method of detecting the type of server is as follows.

Send communication to server to generate a server response

sendServerStatusQuery( );

Parse server response to determine server language

parseServerResponse( ) {

Based on message response type, determine language used by server

if (serverMessageType==PHP) {serverLanguage=PHP}

if (serverMessageType==ASP) {serverLanguage=ASP}

if (serverMessageType==JSP) {serverLanguage=JSP}}

In at least one embodiment, the query module 242 queries other servers of different promotional programs for promotional offers information associated with the user's account.

In another embodiment, the query module also queries the purchase terminal 130 for the device type of the purchase terminal 130. An example of pseudocode illustrating a method that may be used for the determining the device type is as follows.

In the communication from the user device includes a header with Operating System details, search the header for the Operating System type

parseHeader(OStype==getOS( )) {

Set the device type based on the Operating System type and version

if OStype==iOSMobile {deviceType=iPhone series;}

if OStype==iOSTable {deviceType=iPad series;}

if OStype==Windows Surface Edition {deviceType=Surface Tablet;}

if OStype==Windows Home or Windows Pro or MacOS, {deviceType=PC};}

Alternatively, or if the header does not contain information about the Operating System, determine the screen size of the user device

detectDeviceSpecs( ) {

Determine dimensions of user device screen by dividing width and height by dots per inch

determineSizeofDisplayScreenInInches( ) {

widthOfUserDeviceScreen=screen.width/dpi;

heightOfUserDeviceScreen=screen.height/dpi;}}

Search table containing known device specifications to find devices matching specs of user device

lookupDevice(widthOfDeviceScreen,heightOfDeviceScreen) {

Return deviceType from lookup if the width and height of the user's device match the known specifications of a device from the device specifications table deviceType=resultOfQuery(SELECT deviceType FROM deviceSpecificationsTable WHERE device Width=widthOfUserDeviceScreen AND deviceHeight=heightOfUserDeviceScreen);}

In an embodiment, the device type may be used by the promotional offers server 240 to decide the exchange information (e.g., to adjust the price of the goods based on what type of device the user is using).

Conversion module 243 is a module that is configured (e.g., hardwired and/or programmed) to convert promotional offers and/or currencies retrieved from the promotional offers account system 120 and/or 220 to a particular currency and/or to a payment for a product. In an embodiment, the conversion module 243 may convert various promotional offers to values in a currency in circulation (e.g., in US dollars, RMB, etc.). In another embodiment, the conversion module 243 may convert various promotional offers and/or online payment currencies to internal settlement currency values. In an embodiment, the internal settlement currency serves as a virtual currency to be used in the exchange system 100 to facilitate calculations and/or comparisons of the promotional offers in a number of promotional offers programs and/or the prices of product. In an embodiment, the conversion module 243 may convert the internal settlement currency into the value of circulating currencies to pay for the selected product/service in the store 110/210. In another embodiment, the conversion module 243 may convert the prices of product/service in the store 110 to the internal settlement currency values so as to make comparison and/or calculation (e.g., to calculate the amount of promotional offers needed to make the exchange for the product). In yet another embodiment, the conversion module 243 may convert various promotional offers to virtual/digital currency values.

In an embodiment, it is convenient for the promotional offers server 240 to make calculations and/or comparisons using the unit of an internal settlement currency. In an embodiment, the promotional offers server 240 provides a platform for multiple promotional offers programs and various promotional offers in multiple programs are collected to make an exchange/payment. The conversion module 243 may convert the promotional offers in each program (e.g., according to different conversion rules and/or ratios) to values of internal settlement currency, so that a sum of the internal settlement currency value of all promotional programs may be calculated. In an embodiment, the conversion module 243 may further convert the sum of the internal settlement currency to a value of a currency in circulation so as to be compared with the price of the product. In another embodiment, the conversion module 243 converts the price of the product to a value of the settlement currency to make the comparison. In at least one embodiment, the value of the settlement currency that is converted from the prices of the product are further converted by the conversion module 243 to promotional offers, so as to show the number of promotional offers that are required to exchange for the product. In an embodiment, if the sum of the promotional offers is not sufficient to pay for the product, the online payment account of the user in the promotional offers account system 120/220 may be charged. In an embodiment, the currency values in the online payment accounts may be converted to a value of the internal settlement currency.

In at least one embodiment, the conversion module 243 makes conversions according to predetermined rules. In one embodiment, conversion module 243 converts the promotional offers to the internal settlement currency according to a first ratio a first conversion rule. The internal settlement currency may then be converted to a value of a currency in circulation (e.g., US dollars, RMB, Hong Kong dollars) according to a second ratio or a second conversion rule. In an embodiment, different promotional offers programs 221 may have different conversion ratios/rules. For example, airline A, airline B, hotel C, and bank D all provide their own promotional offers programs with different conversion rules, as shown in Table 1.

TABLE 1

| | | | Internal |
|---|---|---|---|
| | | Existing | Settlement |
| Promotional offers | | Promotional | Currency |
| Programs | Conversion Rule | Points | Value |
| Mileage Program | The first 5 km are service fee, and | 500 | 47.5 |
| of Airline A | thereafter every 12 km of the subsequent | | |
| | 120 km are converted to 1 unit of internal | | |
| | settlement currency, and thereafter every | | |
| | 10 km are converted to 1 unit of internal | | |
| | settlement currency. | | |
| Mileage Program | The first 8 km are service fee, and | 1000 | 79.3 |
| of Airline B | thereafter every 16 km of the subsequent | | |
| | 160 km are converted to 1 unit of internal | | |
| | settlement currency, and thereafter every | | |
| | 12 km are converted to 1 unit of internal | | |
| | settlement currency. | | |
| Accommodation | No service fee, and every 20 points are | 5000 | 250 |
| Program of Hotel C | converted to 1 unit of internal settlement | | |
| | currency. | | |
| Reward Program | No service fee, and every 1 point is | 400 | 400 |
| of Bank D | converted to 1 unit of internal settlement | | |
| | currency. | | |

In an embodiment, the conversion rules may reflect service fees. For example, in the mileage program of airline A, the first 5 kilometers (km) count as service fees. Then every 12 km of the subsequent 120 km may be converted to 1 unit of internal settlement currency, and thereafter every 10 km may be converted to 1 unit of internal settlement currency. For example, 500 km of airline A may be converted to 47.5 unites of internal settlement currency. In at least one embodiment, there may be a difference between the price of the product and the promotional offers that are redeemed, which may be deducted from the user's account and applied to a service fee or system maintenance fee. In another embodiment, some promotional programs may not require service fees (e.g., the accommodation program of hotel C, the reward program of bank D). For example, the conversion module 243 may convert 20 points from the reward program of bank D, which does not require a service fee, to redeem to 20 unites of internal settlement currency according to the conversion rule in Table 1.

In an embodiment, the promotional offers server 240 calculates the total value of the internal settlement currency in all the promotional programs listed in Table 1 as 776.8. In an embodiment, the conversion module 243 may convert the total value of the internal settlement currency to a value of a currency in circulation according to a second ratio. For example, 1 unit of internal settlement currency may be converted to 1 U.S. dollar, or RMB 6.1 Yuan, or 7.8 Hong Kong dollars. Thus, the total value of promotional offers in Table 1 (776.8 units of the internal settlement currency) may be converted to 776.8 US dollars, or RMB 4738.48 Yuan, or 6059.04 Hong Kong dollars. In another embodiment, the promotional offers in each of the promotional programs may be individually converted by the conversion module 243 to the circulating currencies by the conversion module 243.

In at least one embodiment, the conversion module 243 may calculate the amount of promotional offers that are required to exchange for selected product. For example, assuming that every 1 unit of internal settlement currency is equivalent to 1 US dollar, to redeem an e-book that costs 20 US dollars, the conversion module 243 may calculate that the required mileage of airline A is: 5+10*12+10*10=225 km (because as indicate in the chart above, the first 5 km are service fee, and thereafter every 12 km of the subsequent 120 km are converted to 1 unit of internal settlement currency, and thereafter every 10 km are converted to 1 unit of internal settlement currency), or the required points of bank D is 20 points. In another embodiment, a combination of different promotional programs and/or online payment methods may be converted by the conversion module 243 and used to pay for the selected product. For example, the conversion module may calculate the required mileage in the mileage program of airline A and the points in the reward program of bank D that may be combined to make the exchange. Thus, an e-book costing 20 US dollars may be purchased by exchanging 5 points in the reward program of bank D plus mileage 5+10*12+5*10=175 km in the mileage program of airline A (as indicated in the above chart). In another example, an item that costs RMB 400 Yuan may be purchased using mileage points in airline A and a credit card or other online payment methods (e.g., PayPal account). For example, the total mileage in the mileage program of airline A is converted to 47.5 internal settlement currency that is further converted to RMB 47.5*6.1=289.75 Yuan. Then a credit card of the user may be charged for RMB 400−289.75=110.25 Yuan. In at least one embodiment, the store 110/210 may display the prices of the product in circulating currencies and/or exchange values of the product including values of promotional offers in various promotional programs and/or online payment methods.

Verification module 244 is a module that is configured (e.g., hardwired and/or programmed) to verify whether the exchange request received from the purchase terminal 130/230 is valid. In at least one embodiment, the verification module 244 determines whether the user's promotional offers accounts are valid. If not valid, the exchange requested is consider invalid and a notice of invalid request is returned from the promotional offers server 240 to the purchase terminal 130/230. If promotional offers accounts are valid, the verification module 244 further determines whether there are sufficient promotional offers and/or remaining balances in the online payment accounts to pay for the selected product. In an embodiment, the verification module 244 may determine whether the total value of currency in circulation converted by the conversion module 243 using the promotional offers is greater than or equal to the price of the selected product in currency in circulation. In another embodiment, the verification module 244 may determine whether the total value of internal settlement currency converted by the conversion module 243 using the promotional offers is greater than or equal to the price of the selected product converted to internal settlement currency. In yet another embodiment, the verification module 244 may determine whether the total amount of the promotional offers is greater than or equal to the value of promotional offers that are converted by the conversion module 243 from the price of the selected product. In an embodiment, if there are insufficient promotional offers, the verification module 244 may further determine whether the remaining balance in the user's online payment accounts (e.g., PayPal account, or other online payment currencies) is sufficient to fill in the gap (e.g., to pay for the balance due after deduction of the promotional offers).

In at least one embodiment, if there are sufficient promotional offers and/or online payment currencies to make the exchange, the exchange request is considered valid. The promotional server 240 may request a confirmation from the purchase terminal 130/230 to process the exchange transaction. If there are not sufficient promotional offers and/or online payment currencies to make the exchange, the exchange request is considered invalid and a notice that the request is invalid is sent to the purchase terminal 130/230, notifying the user of insufficient promotional offers to make the exchange/purchase.

Transaction module 245 is a module that is configured (e.g., hardwired and/or programmed) to process the exchange transaction. In at least one embodiment, the transaction module 245, in response to the confirmation of exchange received from the purchase terminal 130/230, sends a request to the promotional offers account system 120/220 to deduct corresponding promotional offers that are required to make the exchange, and/or to deduct the corresponding amount of currencies in the user's online payment accounts required to pay for the balance due after deduction of the promotional offers. In at least one embodiment, the transaction module 245 receives a confirmation of deduction from the promotional offers account system 120/220, and then sends to the store 110/210 a request to process the order and/or to provide the selected product to the user (e.g., send a download link/code, prepare for pickup or delivery). In an embodiment, the transaction module 245 may receive a message from the store 110/210 that the order has been processed, and the transaction module 245 then sends a message to the purchase terminal 130/230 confirming that the purchase of the selected product is successful. In another embodiment, the transaction module 245 may receive information about the product (e.g., download link/code), and may forward the information to the purchase terminal 130/230.

Exchange mode module 246 is a module that is configured (e.g., hardwired and/or programmed) to provide a variety of exchange modes to make the purchase. In an embodiment, the exchange mode module 246 provides information including, but not limited to, the prices of the product in a currency in circulation, the exchange values of the product according to various promotional offers in various promotional programs, the value of the product in an internal settlement currency, based on rules and restrictions of the conversion module 243 and/or information about the user. The exchange mode module 246 also provides the available promotional offers (e.g., the amount of promotional offers, the value of the promotional offers converted to a currency in circulation and/or to an internal settlement currency) and/or remaining balances in the user's online payment accounts in the promotional offers account system 120/220 that is obtained by the query module 242. In at least one embodiment, the exchange mode module 246 provides a variety of exchange modes for the user to select. For example, the user may select a single promotional program for the exchange. Alternatively, the user may select a combination of certain promotional programs (e.g., the four programs in Table 1) and/or online payment methods (such as credit cards, debit cards, and/or debiting a user's bank account).

Purchase restriction module 247 is a module that is configured (e.g., hardwired and/or programmed) to set restrictions and/or limitations on the exchange of promotional offers for products. For example, the purchase restriction module 247 may set restrictions that certain products cannot be exchanged using certain promotional offers. In another example, the promotional offers may be used in exchange for a limited number of products. In an embodiment, the purchase restriction module 247 may also set restrictions for the time period during which certain promotional offers may or may not be redeemed. In another embodiment, the purchase restriction module 247 may limit the types and/or numbers of promotional offers that could be combined to make purchases.

Analysis module 248 is a module that is configured (e.g., hardwired and/or programmed) to analyze user information and/or promotional information. In an embodiment, the analysis module 248 reviews and summaries user information and/or promotional information retrieved by the query module 242. In an embodiment, the analysis module 248 may review and analyze the promotional information in the promotional offers programs 221, which may have different rules and/or different data elements for supporting the rules among different programs. In an embodiment, the analysis module 248 reviews and interfaces with one type of promotional offers program. In another embodiment, the analysis module 248 reviews and interfaces with multiple types of promotional offers programs, in which the rules and hence data requirements may be different. In an embodiment, the promotional offers server 240 does not need to standardize data elements from different promotional programs. In an embodiment, the analysis module 248 reviews and analyzes different promotional information associated with different promotional offers programs.

In an embodiment, the analysis module 248 may be connected with social networks (e.g., Facebook, Twitter, blog, etc.), shopping websites, and/or searching engines to collect and analyze information about browsing history, searching history, purchase history, and/or posts of the user. The analysis module 248 may also analyze the information of consumption/exchange history of the user recorded by the promotional offers server 240. The analysis module 248 analyzes the information collected to predict the user's shopping habits and/or personal preferences. In at least one embodiment, the analysis module 248 provides information for the promotional offers server 240 to adjust prices of certain product, adjust exchange values and/or rules, and/or provide advertisement of certain products to attract the user to redeem his/her promotional offers. For example, after the server analyzes the information about the user, the server predicts, based on the information about the user, a product that is interesting to the user. Then the server adjusts a value of the product that is predicted to be interesting to the user. The new value of the product may be at least as much as a plurality of promotional offers.

Price adjustment module 249 is a module that is configured (e.g., hardwired and/or programmed) to adjust prices and/or exchange values of products. In an embodiment, the price adjustment module 249 may adjust/change prices and/or exchange values regularly, in a certain time period, or under certain conditions. For example, the price adjustment module 249 may apply promotional discounts to the product in the entire store in a preset period of time (e.g., during holidays or a black Friday). In another example, the price adjustment module 249 may adjust how many products are on sale while other products are not. In another example, the price adjustment module 249 may adjust the prices and/or exchange values of certain types of products in a preset period with additional limitations (e.g., a requirement to use a certain payment method, to purchasers with certain coupons, limiting the adjusted price to the first 100 customers, etc.). In yet another example, in a particular time period, the price adjustment module 249 may adjust the price of products only if certain promotional offers are used in exchange for the products. In at least one embodiment, the price adjustment module 249 applies discounts and/or promotions when the products are purchased and/or when the promotional offers are redeemed. In an embodiment, the price adjustment module 249 may make different adjustments of prices for different users based on the information about the users. For example, according to the shopping habits or browsing history of a user, the price adjustment module 249 may apply bigger discounts on the products that are predicted to be more interesting to the user, or may lower the exchange value of the most interesting product to attract the user to redeem his/her promotional offers. In an embodiment, the price adjustment module 249 may adjust the prices of product according to the pathway through which the user accesses the Internet or the promotional offers server 240. For example, a customer using a mobile device may have a cheaper way to buy an item and may receive fewer promotional offers (e.g., fewer mileage points). In another example, a customer using a computer based browser may have a cheaper way to buy an item and may receive fewer promotional offers.

In an embodiment, the price adjustment module 249 may adjust the prices of products, so that the products may have different exchange values if different promotional programs are used to purchase the products. Table 2 shows that the exchange values (in terms of the internal settlement currency converted by the conversion module 243) are different if the user selects the reward program of the Bank of China, the mileage program of China National Aviation Corporation, or other payment methods. The difference of exchange values or prices among different promotional programs may be constant, or may be time sensitive and could be adjusted again by the price adjustment module 249.

TABLE 2

| | | Adjusted Price (in terms of the internal |
|---|---|---|
| Price | Payment Method | settlement currency) |
| 1 | Reward program of | 80 |
| | Bank of China | |
| 2 | Mileage program of | 90 |
| | China National | |
| | Aviation Corporation | |
| 3 | Other payment | 100 |

In one embodiment, after the completion of the purchase of the selected product, the price adjustment module 249 follows up and immediately offers a promotional offer for purchasing or downloading other product. For example, the price adjustment module 249 may adjust the prices of product that could be used together with the purchased product to attract the user to make another purchase.

Communications module 250 is a module that is configured (e.g., hardwired and/or programmed) to transmit and/or receive signals. In at least one embodiment, the communications module 250 may include at least a transmitter and a receiver. In at least one embodiment, the communications module 250 is adapted (e.g., hardwired, configured, and/or programmed) to communicate, via the network 150 with the store 110 and/or 210, the purchase terminal 130 and/or 230, and/or the promotional offers account system 120 and/or 220.

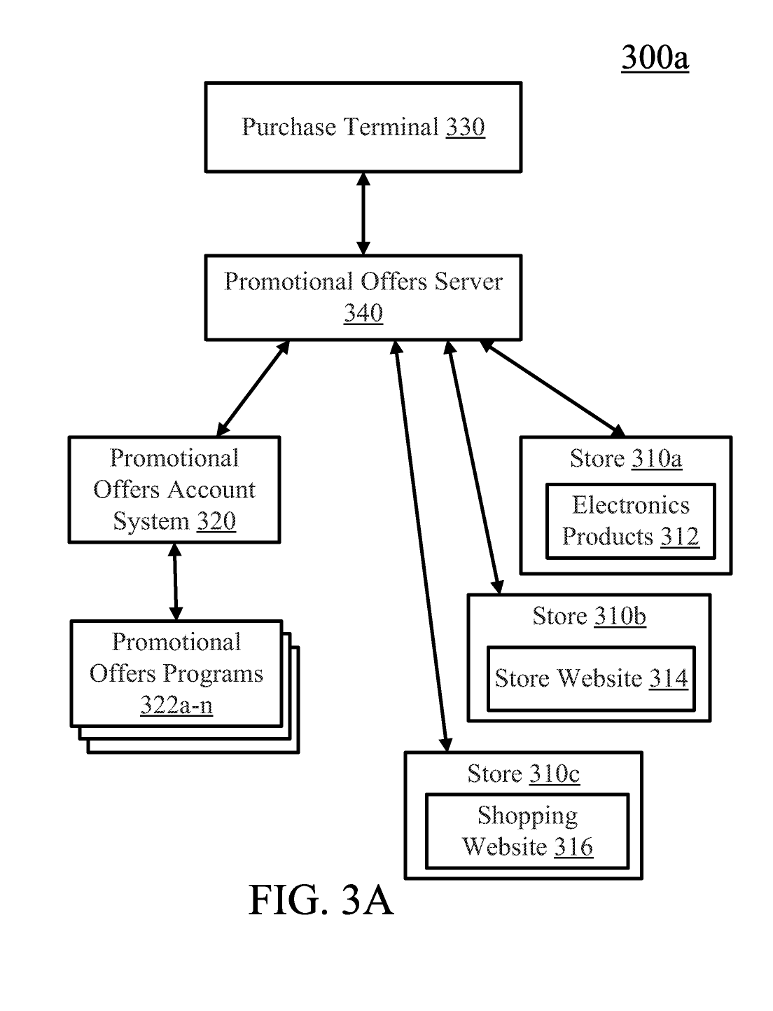

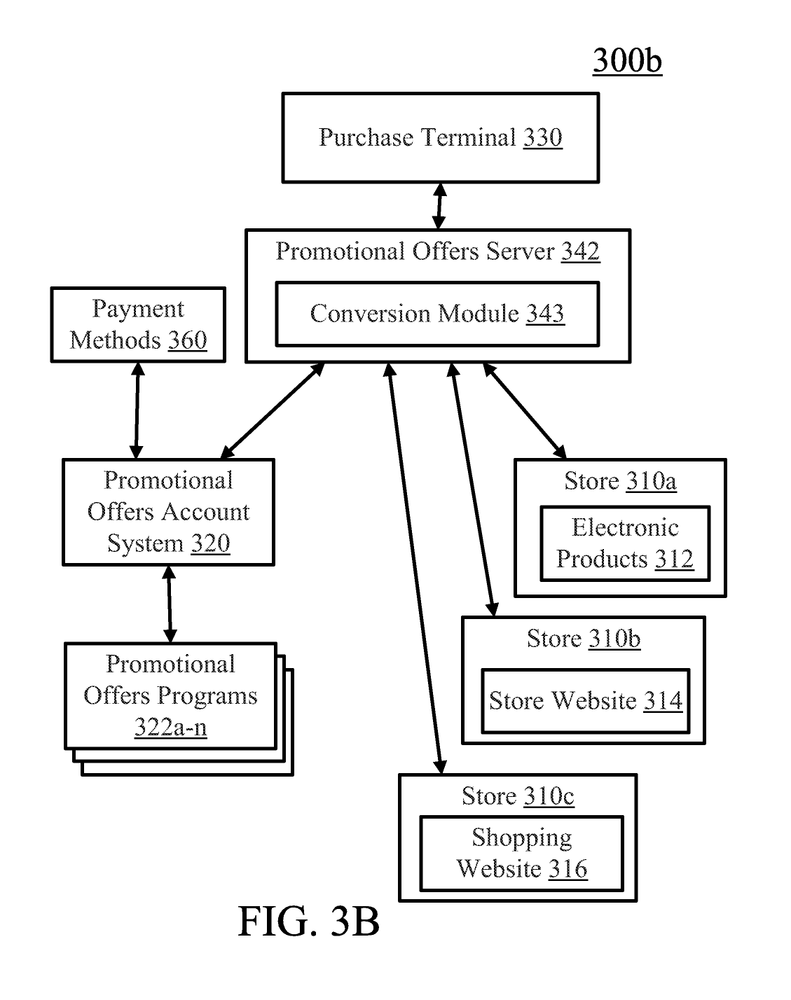

FIG. 3A illustrates a block diagram of another embodiment of the exchange system 100a of FIG. 1A. Exchange system 300a includes at least store 310a, 310b, and 310c, electronics products 312, store website 314, shopping website 316, promotional offers account system 320, promotional offers programs 322a-n, purchase terminal 330, and promotional offers server 340. In other embodiments, the exchange system 300a may not have all of the elements or features listed and/or may have other elements or features instead of, or in addition to, those listed.

Stores 310a, 310b, and 310c may be embodiments of the stores 110 or 210, which were discussed in conjunction with FIGS. 1A and 2A. Stores 310a, 310b, and 310c may be the same store or different stores. Electronics products 312 is an example of products that may be carried by store 110 or 210. In other embodiments other products may be included in addition to or instead of electronics products 312. Store website 314 and shopping website 316 may be embodiments of the store website 211 and shopping website 212, respectively, which were discussed in conjunction with FIG. 2A. Promotional offers account system 320, purchase terminal 330, and promotional offers server 340 may be embodiments of the promotional offers account systems 120 or 220, purchase terminals 130 or 230, and promotional offers servers 140 or 240, respectively, which were discussed in conjunction with FIGS. 1A and 2B-D. Promotional offers programs 322a-n may be embodiments of the promotional offers programs 221, which was discussed in conjunction with FIG. 2B.

Electronics products 312 includes, but are not limited to, software applications, game applications, e-books, and multimedia that may include movies, TV plays, and music, etc.

FIG. 3A shows that the purchase terminal 330 communicates with the promotional offers server 340 to redeem promotional offers that may be from various promotional offers programs 322a-n in the promotional offers account system 320 for products in stores 310a-c. The purchase terminal 330 may be a mobile device with an Internet connection and/or mobile network connection. Alternatively, the purchase terminal 330 may be a personal computer with an Internet connection. The purchase terminal 330 may be communicatively connected to the promotional offers server 340 using different connection protocols (e.g., Internet Protocol (IP) that make use of public and private network to establish connection for transactional exchange). In an embodiment, the purchase terminal 330 initiates a Hypertext Transfer Protocol (HTTP) connection to the promotional offers server 340, via a web browser, from the purchase terminal 330, and establishes a transactional session between the purchase terminal 330 and the promotional offers server 340. In another embodiment, the purchase terminal 330 initiates a Remote Procedure Call (RPC) from a program running on the purchase terminal 330 to the promotional offers server 340 and establishes a transactional thread on the service program running on the promotional offers server 340. In at least one embodiment, the HTTP connection and/or the RPC are encrypted. An example of psuedocode illustrating a method of determining the security protocol to implement is as follows.

Based on the server language, perform
(1) a lookup of SSL (secure socket layer) protocols or other security protocols associated with the server language and/or type, and
(2) a lookup of the steps required for using the security protocol

if(serverLanguage==PHP) {

securityProtocolTypes[ ]=resultOfQuery(SELECT securityProtocols FROM securityProtocolsTable WHERE serverLanguage=PHP);

securityProtocolUsageSteps[ ]=resultOfQuery(SELECT usageSteps FROM

securityProtocolsTable WHERE serverLanguage=PHP);

Set the security protocol(s) to be used when communicating securely with the server, then apply steps needed to use security protocol(s)

setSecurityProtocol=securityProtocolTypes[i];

applyUsageSteps(securityProtocolUsageSteps[i];}

In an embodiment, the steps involved with using a particular security protocol to communicate with a server may include, making a ssl_get_cert request to retrieve a digital certificate, using a ssl_pkey_get_public_key method for extracting the public key from the digital certificate, making a ssl_csr_get_private_key request to retrieve a private key by providing the public key, using a ssl_private_decrypt method to decrypt messages received from a server by applying the private key, and using a ssl_private_encrypt method to encrypt messages to be sent to a server by applying the private key.

In at least one embodiment, the purchase terminal 330 allows the user to input user account information (e.g., an account identification, a token to access promotional offers programs), and transmits the user account information to the promotional offers server 340. In one embodiment, the transmission of user account information is encrypted. The promotional offers server 340 uses the received user account information to established an encrypted communication session with the promotional offers account system 320 and a request for information about available promotional offers and/or the remaining balance in an online payment accounts. In one embodiment, the promotional offers server 340 and the promotional offers account system 320 reside on the same computing device and/or server. In another embodiment, the promotional offers server 340 and the promotional offers account system 320 reside on different computing devices and/or servers, and the promotional offers server 340 and the promotional offers account system 320 may be connected by a local area network or by public Internet Protocol network.

In at least one embodiment, the promotional offers account system 320 includes user account information and/or other information about the user. Upon receiving the request from the promotional offers server 340, the promotional offers account system 320 retrieves the user's available promotional offers and/or remaining balance in the user's online payment accounts.

In an embodiment, the promotional offers server 340 supports only one promotional offers program. For example, the promotional offers server 340 acts as a sub-module of the promotional offers a program run by a bank, and the promotional offers server 340 can use the promotional offers awarded by the bank to perform online purchases. In the embodiment in which the promotional offers server 340 supports a single promotional offers program, the promotional offers server 340, the promotional offers account system 320, and the promotional offers program that are being supported may all reside in the secured environment of the bank, for example.

In another embodiment, the promotional offers server 340 serves as a platform to allow the user to access various promotional offers in multiple promotional offers programs 322a-n. The promotional offers account system 320 and the promotional offers server 340 may reside on the same computer and/or server, or on the same local area network (LAN), while the promotional offers programs 322a-n reside outside the LAN and are connected, via a secured, encrypted public network that uses Internet Protocol or another secured private network that connects to the LAN on which the promotional offers account system 320 resides.

In yet another embodiment, the promotional offers account system 320 is managed and housed by a third party, while the connection between the promotional offers account system 320 and the promotional offers server 340 is separate by one or more firewall(s). In an embodiment, the execution and login of the promotional offers account system 320 and the connection between the promotional offers account system 320 and various promotional offers programs 322a-n are completely outside of the control by the promotional offers server 340, so as to prevent any security leak or fault within the promotional offers server 340 from affecting the integrity of the promotional offers account system 320 and/or the promotional offers programs 322a-n.

In at least one embodiment, the promotional offers server 340 is connected via secured and/or encrypted connections to one or more of the stores 310a-n. In at least one embodiment, users may use the purchase terminal 330 to access, via the promotional offers server 340, the stores 310a-n and make purchases and/or redeem promotional offers for electronics products 312 and/or other products and/or services on online stores, mobile play stores, store website 314, and/or shopping website 316.

FIG. 3B illustrates a block diagram of an embodiment of the exchange system 300a of FIG. 3A with options for other payment methods. Exchange system 300b includes at least stores 310a, 310b, and 310c, electronics products 312, store website 314, shopping website 316, promotional offers account system 320, promotional offers programs 322a-n, and purchase terminal 330, which were discussed in conjunction with FIG. 3A. Exchange system 300b further includes a promotional offers server 342, which includes a conversion module 343, and payment methods 360. In other embodiments, the exchange system 300b may not have all of the elements or features listed and/or may have other elements or features instead of, or in addition to, those listed.

Promotional offers server 342 may be an embodiment of any of the promotional offers servers 140, 240, and 340, which were discussed in conjunction with FIGS. 1A, 2D, and 3A, respectively. Conversion module 343 may be an embodiment of the conversion module 243, which was discussed in conjunction with FIG. 2D. The conversion module 343 may convert the promotional offers retrieved from the promotional offers account system 320 to values in a currency in circulation or internal settlement currency values.

Payment methods 360 include external payment methods and/or gateways to other methods of making payments, other than using the promotional offers and the online payment accounts in the promotional offers account system 320. In an embodiment, the payment methods 360 may include a payment gateway that is an e-commerce application service provider service that authorizes credit card payments for e-businesses, online retailers, bricks and clicks, or traditional brick and mortar. In at least one embodiment, when the promotional offers are insufficient to pay for the goods, the user may choose to pay for the remaining balance using a credit card or other payment methods through the payment gateway. In an embodiment, the payment gateway may be an internal or external application service provider or other online service that determines which of, and/or authorizes one of, a variety of payment methods, such as credit card payments for e-business, online retailer, or other retailers and/or stores. The external payment gateway may facilitate the transfer of information between the promotional offers servers 140, 240, and 340, and the provider of a payment method. In an embodiment, the payment methods 360 may include a payment gateway established by one of the credit card (or debit card) issuing banks in the US and/or other countries. Alternatively or additionally, the payment methods 360 may include other online and/or mobile payment methods. In at least one embodiment, if the sum of available promotional offers and/or the remaining balance in the online payment accounts in the promotional offers account system 320 is not sufficient for paying for the selected product, the payment methods 360 may be used to pay for the value that is required to complete the transaction. In at least one embodiment, the promotional offers account system 320 is connected to a number of payment gateways of payment methods 360, via established and/or predefined secured connections. In an embodiment, the promotional offers account system 320 may send a command for the payment gateway to deduct the corresponding value of currency in the user's account of the payment methods 360.

In an embodiment, the user may select from different exchange modes provided by the exchange mode module 246 of the promotional offers server 240. In an embodiment, the user may use the purchase terminal 330 to send to the promotional offers account system 320 (directly or via the promotional offers server 342) a request to make a partial or an entire payment using one or more of the promotional program and/or payment methods 360. In an embodiment, the promotional offers server 342 may set limitations and/or restriction on the product from the stores 310a-c. For example, certain products may only be purchased using certain promotional programs of the promotional offers programs 322a-n and/or certain payment methods of the payment methods 360.

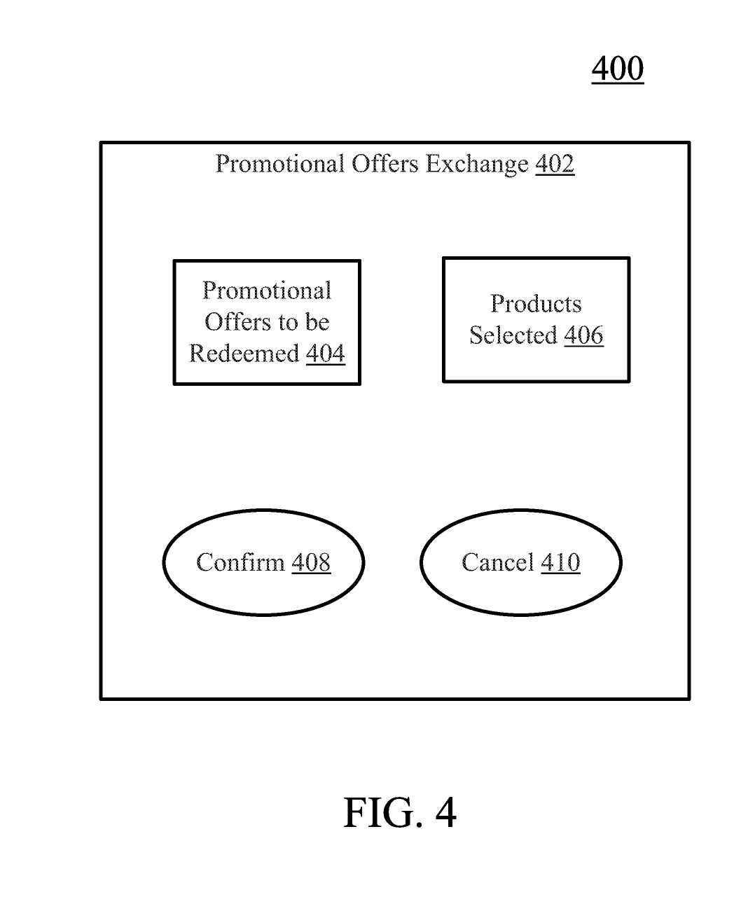

FIG. 4 illustrates a view 400 of an interface of an embodiment of the mobile app 232 of FIG. 2C. Program interface 400 includes at least promotional offers redemption 402, promotional offers to be redeemed 404, products selected 406, confirm 408, and cancel 410. In other embodiments, the program interface 400 may not have all of the elements or features listed and/or may have other elements or features instead of, or in addition to, those listed.

FIG. 4 shows a program interface 400 on the purchase terminal 130 (e.g., a mobile device of the user), on which the user can perform exchange of promotional offers for products that the user selected. In at least one embodiment, the program interface 400 may display the products selected by the user and promotional offers and/or currencies that are required for the purchase of the product. In an embodiment, the user can adjust the quantity of product and/or change the selected product to a different product (e.g., by clicking on the product, the program interface 400 may be redirected to the online store or website for the user to select other product). Upon the selection of the new product, the program interface 400 would accordingly display another number of promotional offers and/or another monetary value required for the newly selected product. The program interface 400 provides options such as “confirm” and “cancel” for the user to determine whether to proceed with the exchange or to cancel the process of the exchange. Alternatively, the “confirm” and “cancel” options may be replaced by OK button and cancel button on the program interface 400.

Promotional offers exchange 402 is representation of a view of a program interface on the purchase terminal that may be used to exchange promotional offers for products. In an embodiment, the exchange system 100a provides a platform for using various promotional offers from various promotional offers programs 221 or 322a-n to make a payment for selected product. The exchange system 100a also allows the user to select, via the purchase terminal 130, 230, and/or 330, electronic products and/or non-electronic products from various stores. In at least one embodiment, a common Application Program Interface (API) is provided to the purchase terminal 130 that may be incorporated in an application for purchase terminal 130, via which the user, via the application on the purchase terminal 130, to exchange using promotional offers from various promotional offers programs for products selected from various stores. In an embodiment, the user may use the promotional offers exchange 402 to pay for the goods using another selection of promotional offers (e.g., when the purchase terminal 130 shows different selections of promotional offers that may be redeemed). The different selections of promotional offers may or may not have different rules and/or data requirements. In an embodiment, the common API on the purchase terminal 130 creates a stable (in terms of programming change) environment for the purchase terminal 130. The promotional offers exchange 402 is a view of the interface, via which the user may confirm the exchange or cancel the transaction. In at least one embodiment, the application program on the purchase terminal 130, 230, or 330 may be directly linked to the promotional offers server so that the selected electronic product may be directly downloaded upon successful deduction of the promotional offers.

Promotional offers to be redeemed 404 is a list of promotional offers and/or online payment currencies in the user's accounts, which may be redeemed to pay for the selected products. In an embodiment, information about the promotional offers to be redeemed 404 is retrieved from the promotional offers account system 120, 220, and/or 320.

Products selected 406 is a display of the products and/or services that are selected by the user from the stores 110, 210, 310a-c. The products selected 406 may include electronic products and/or non-electronic products.

Confirm 408 is a button or link on the interface which may be activated (e.g., by being clicked and/or tapped), so that a signal may be transmitted to the promotional offers server to proceed with the exchange transaction. In an embodiment, after the user clicks the confirmation 408, the purchase terminal 130, 230, or 330 sends a confirmation signal to the promotional offers server 140, 240, 340, or 342 that further sends a request to the promotional offers account system 120, 220, or 320 to deduct the promotional offers to be redeemed 404.

Cancel 410 is a button or link on the interface which may be activated (e.g., clicked and/or tapped), and the exchange session using the program on the purchase terminal 130, 230, or 330 is then canceled.

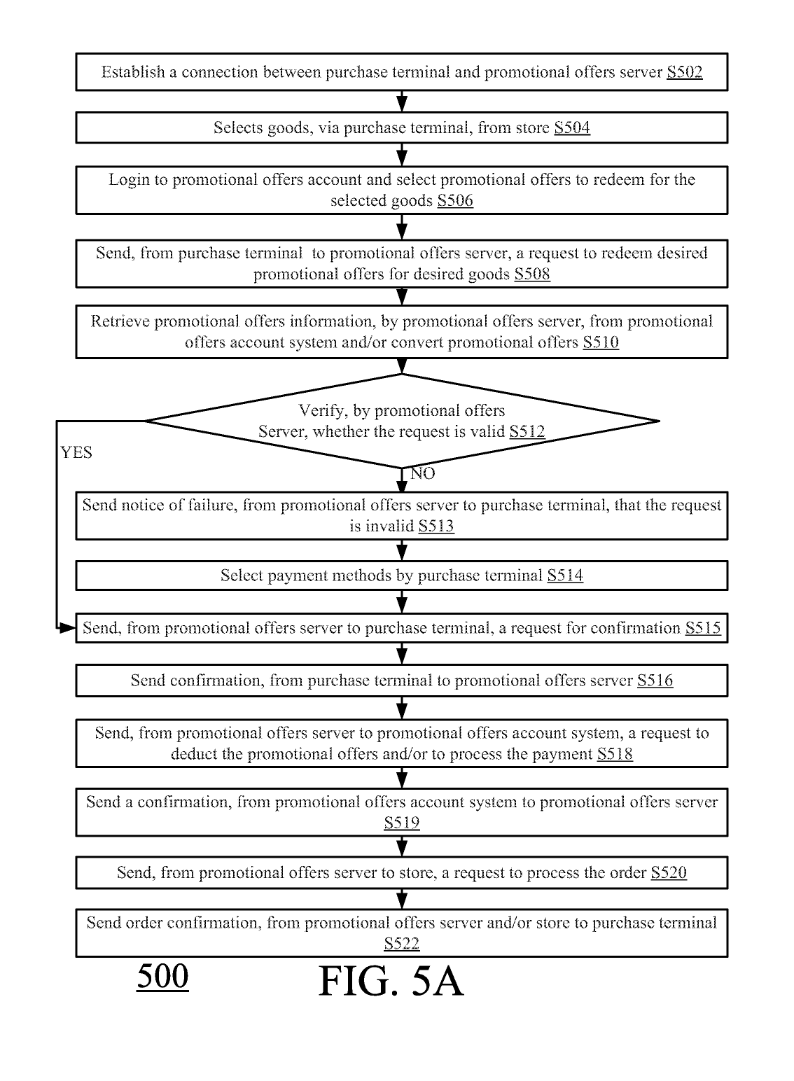

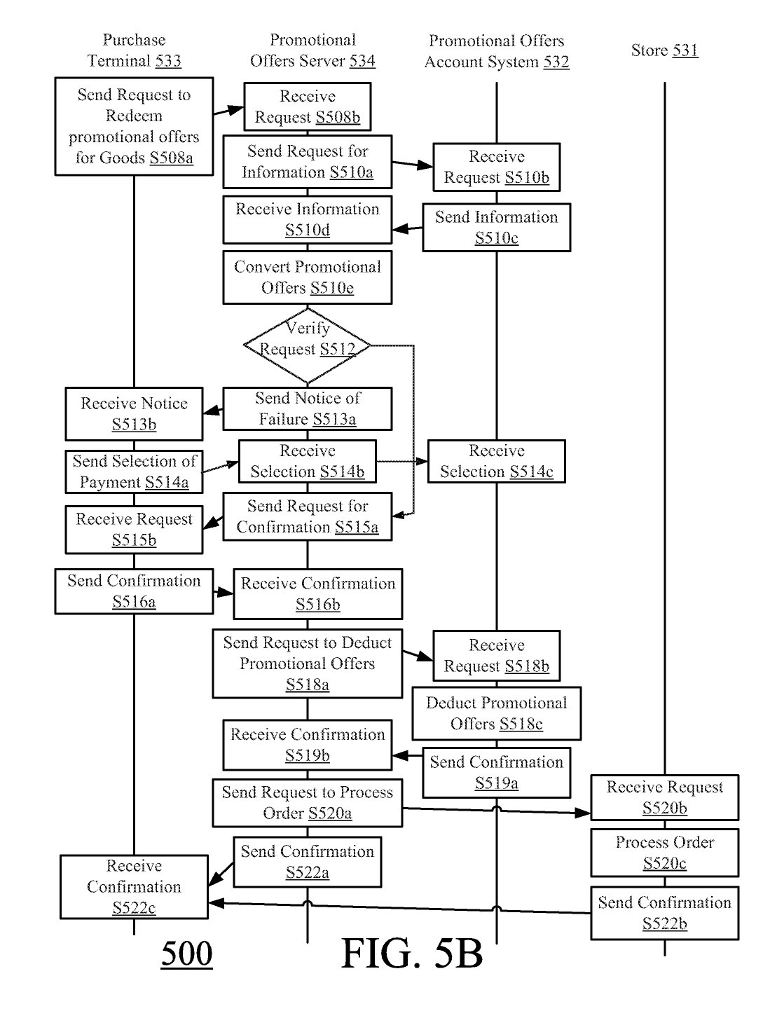

FIGS. 5A and 5B are flowcharts of an embodiment of a method 500 of exchanging promotional offers for product by the exchange system described in any one of FIGS. 1A, 1B, 2A-D, 3A, 3B, and 4. Store 531 may be any of the stores 110, 210, and 310. Promotional offers account system 532 may be any of the promotional offers account systems 120, 220, and 320. Purchase terminal 533 may be any of the purchase terminals 130, 230, and 330. Promotional offers server 534 may be any of the promotional offers servers 140, 240, and 340.

FIG. 5A is related to FIG. 5B in that FIG. 5B shows further details of optional embodiments of the method 500 of FIG. 5A. FIG. 5B also clarifies which terminal performs each of the steps of FIG. 5A. In FIG. 5B, the steps are placed on different parallel, vertical lines in which each line represents the terminal that performs the indicated step. The collections of steps located on the same line are the steps performed by that terminal and represent a method implemented by that terminal.

In step S502 (FIG. 5A), a communications connection is established between the purchase terminal 533 (FIG. 5B) and the promotional offers server 534 (FIG. 5B). As part of step S502, a communications connection is established between the purchase terminal 533 (FIG. 5B) and the store 531 (FIG. 5B) and the promotional offers account system 532 (FIG. 5B).

In step S504 (FIG. 5A), the purchase terminal 533 (FIG. 5B) is used to select product from the store 531 (FIG. 5B).

In step S506 (FIG. 5A), the purchase terminal 533 (FIG. 5B) is used to login to promotional offers account in the promotional offers account system 532 (FIG. 5B) and promotional offers are selected to redeem for the selected product.

In step S508 (FIG. 5A), the purchase terminal 533 (FIG. 5B) sends a request to the promotional offers server 534 (FIG. 5B) to redeem/exchange the selected promotional offers for the selected product. In sub-step S508a (FIG. 5B), the purchase terminal 533 sends a request for redeeming promotional offers for product. In sub-step S508b, the promotional offers server 534 receives the request.

In step S510 (FIG. 5A), the promotional offers server 534 retrieves the user's promotional offers information and/or currency information in the user's accounts from the promotional offers account system 532. As part of step S510, the promotional offers server 534 may calculate and convert the promotional offers and/or currencies of the user to internal settlement currency values or values in a currency in circulation. As part of step S510, the promotional offers server 534 may also calculate a sum of currency values converted from various promotional offers and/or currencies of the user. In sub-step S510a (FIG. 5B), the promotional offers server 534 sends a request for information of promotional offers and/or currencies in the user's accounts. In sub-step S510b (FIG. 5B), the promotional offers account system 532 receives the request. In sub-step S510c (FIG. 5B), the promotional offers account system 532 sends corresponding information. In sub-step S510d (FIG. 5B), the promotional offers server 534 receives the information. In sub-step S510c, the promotional offers server 534 calculates and converts the promotional offers and/or currencies of the user.

In step S512, the promotional offers server 534 verifies if the request is valid. As part of step S512, the promotional offers server 534 determines whether the promotional offers or the converted currency values are sufficient to pay for the selected product. If yes, the request is considered valid and the method 500 proceeds to step S515. If no, the request is considered invalid and the method 500 proceeds to step S513.

In step S513 (FIG. 5A), the promotional offers server 534 sends a notice of invalid request to the purchase terminal 533. As part of step S513, promotional offers server 534 sends a message to the purchase terminal to pay by other payment methods (e.g., credit card, debit card). The message may include options of payment methods for the user to select. In sub-step S513a (FIG. 5B), the promotional offers server 534 sends a notice of invalid request with a selection of options to pay by other methods. In sub-step S513b (FIG. 5B), the purchase terminal 533 receives the notice with a selection of other payment methods to choose from.

In step S514 (FIG. 5A), the purchase terminal 533 is used to select a payment method(s) to pay for the amount that is needed for completing the exchange and send to either the promotional offers server 534 or the promotional offers account system 532. In sub-step S514a (FIG. 5B), the purchase terminal 533 selects a payment method(s) and sends the selection. In sub-step S514b (FIG. 5B), the promotional offers server 534 receives the selection of payment. In sub-step S514c (FIG. 5B), the promotional offers account system 532 receives the selection of payment.

In step S515 (FIG. 5A), the promotional offers server 534 sends to the purchase terminal 533 a request for confirmation of the exchange. In sub-step S515a (FIG. 5B), the promotional offers server 534 sends a request for confirmation. In sub-step S515b (FIG. 5B), the purchase terminal 533 receives the request.

In step S516 (FIG. 5A), the purchase terminal 533 sends the confirmation of exchange to the promotional offers server 534. In sub-step S516a (FIG. 5B), the purchase terminal 533 sends a confirmation. In sub-step S516b (FIG. 5B), the promotional offers server 534 receives the confirmation.

In step S518 (FIG. 5A), the promotional offers server 534 sends to the promotional offers account system 532 a request to deduct the promotional offers and/or currencies that are needed to make the exchange. As part of step S518, if the promotional offers and/or currencies from the user's accounts are not sufficient, the promotional offers server 534 may further process payment using the selected payment method(s), or request the promotional offers account system 532 to process the payment. In sub-step S518a (FIG. 5B), the promotional offers server 534 sends a request to deduct promotional offers and/or process the payment. In sub-step S518b (FIG. 5B), the promotional offers account system 532 receives the request. In sub-step S518c (FIG. 5B), the promotional offers account system 532 deducts the promotional offers that are needed to make the exchange. The promotional offers account system 532 or the promotional offers server 534 may process the payment if required for the exchange.

In step S519 (FIG. 5A), the promotional offers account system 532 sends a confirmation back to the promotional offers server 534 upon successful deduction of the promotional offers and/or completion of payment. In sub-step S519a (FIG. 5B), the promotional offers account system 532 sends a confirmation. In sub-step S519b (FIG. 5B), the promotional offers server 534 receives the confirmation.

In step S520 (FIG. 5A), the promotional offers server 534 sends to the store 531 a request to process the order. In sub-step S520a (FIG. 5B), the promotional offers server 534 sends a request for processing the order. In sub-step S520b (FIG. 5B), the store 531 receives the request. In sub-step S520c (FIG. 5B), the store 531 processes the order accordingly (e.g., prepare product for delivery or pickup, transmit electronic product or provide download information).

In step S522 (FIG. 5A), the promotional offers server 534 and/or the store 531 sends order confirmation to the purchase terminal 533. In sub-step S522a (FIG. 5B), the promotional offers server 534 sends an order confirmation the purchase terminal 533. In sub-step S522b (FIG. 5B), the store 531 sends an order confirmation to the purchase terminal 533. In sub-step S522c (FIG. 5B), the purchase terminal 533 receives the order confirmations. Alternatively there may be only one order confirmation, which may be sent by store 531 or promotional offer server 534. Alternatively, the store 531 sends a confirmation to promotional offers server 534, which then sends a confirmation to purchase terminal 533, confirming the order.

In an embodiment, each of the steps of method 500 is a distinct step. In at least one embodiment, although depicted as distinct steps in FIGS. 5A and 5B, step S502-S522 may not be distinct steps. In other embodiments, method 500 may not have all of the above steps and/or may have other steps in addition to or instead of those listed above. The steps of method 500 may be performed in another order. Subsets of the steps listed above as part of method 500 may be used to form their own method.

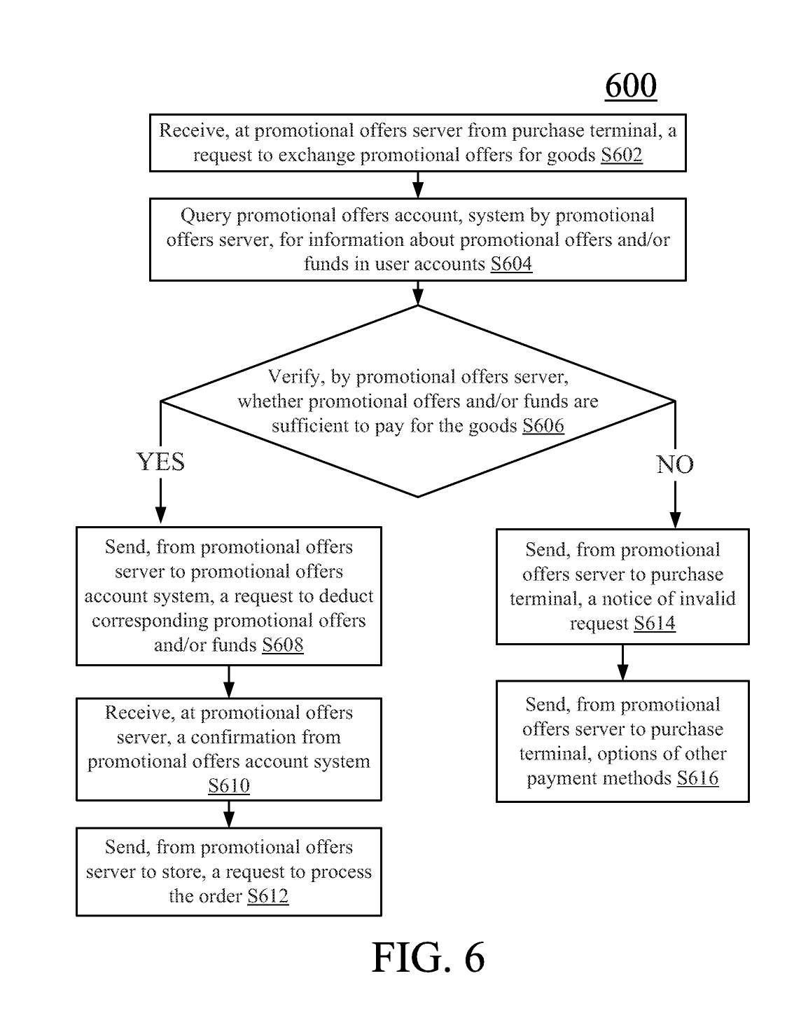

FIG. 6 shows a flowchart of an embodiment of a method 600 of verifying the exchange request. Method 600 is an embodiment of the portion of method 500 that is implemented by the promotional offers server.

In step S602, the promotional offers server receives from the purchase terminal a request to exchange promotional offers for product. Step S602 may be an embodiment of step S502

In step S604, the promotional offers server queries the promotional offers account system for information about the promotional offers and/or funds in the user's accounts. Step S604 may be an embodiment of step S510.

In step S606, the promotional offers server verifies whether the promotional offers and/or funds from the user's accounts are sufficient to pay for the selected product. If yes, the request is considered valid and method 600 proceeds to step S608. If no, the request is considered invalid and method 600 proceeds to step S614. Step S606 may be an embodiment of step 512.

In step S608, if the request for exchange is valid, the promotional offers server sends a request to the promotional offers account system to deduct corresponding promotional offers and/or funds. Step S608 may be an embodiment of step S518.

In step S610, the promotional offers server receives confirmation from promotional offers account system upon successful deduction of the promotional offers and/or funds in the user's accounts. Step 610 may be an embodiment of step S519.

In step S612, the promotional offers server sends a request to the store to process the order. Step S612 may be an embodiment of step S520.

In step S614, if the request for exchange is invalid, the promotional offers server sends a notice of invalid request to the purchase terminal. Step S614 may be an embodiment of Step S513.

In step S616, the promotional offers server sends options of other payment methods to the purchase terminal. In an embodiment step S616 may be included in part of step S513.

In an embodiment, each of the steps of method 600 is a distinct step. In at least one embodiment, although depicted as distinct steps in FIG. 6, step S602-S616 may not be distinct steps. In other embodiments, method 600 may not have all of the above steps and/or may have other steps in addition to or instead of those listed above. The steps of method 600 may be performed in another order. Subsets of the steps listed above as part of method 600 may be used to form their own method.

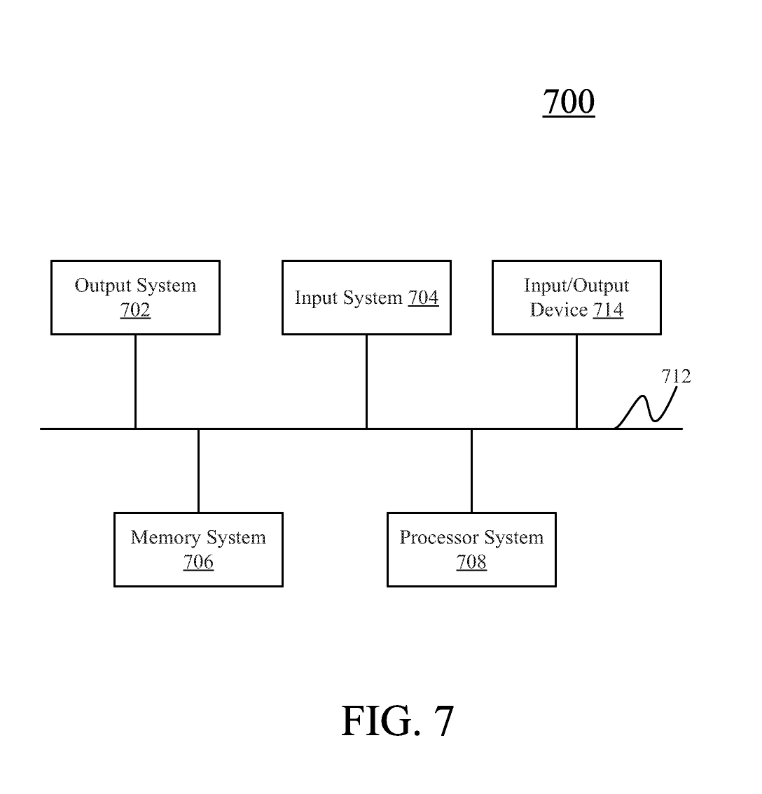

FIG. 7 shows a block diagram of an embodiment of a computer system 700 used in at least one embodiment. The computer system 700 may include output system 702, input system 704, memory system 706, processor system 708, communications system 712, and input/output system 714. In other embodiments, computer system 700 may include additional components and/or may not include all of the components listed above.

Computer system 700 is an example of a computer that may be used for the store 110, 210, 310, or 531, the promotional offers server 140, 240, 340, or 534, and/or promotional offers account systems 120, 220, 320, and 532 in at least one embodiment.

Output system 702 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. In an embodiment of computer system 700 that is used as a terminal in a store, output system 702 may include a display for displaying product information, exchange information, and/or order information for a store assistant to process the order after receiving a confirmation from the promotional offers server. Output system 702 may also include an interface for communicating, via a network (e.g., the network 150) with the purchase terminal and/or other terminals/systems in the exchange system 100a.

Input system 704 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. In an embodiment of computer system 700 that is used as a terminal in a store, input system 704 may include keys and/or buttons for the store assistant to confirm the processing of orders and/or updating/tracking of inventory.

Memory system 706 may include, for example, any one of, some of, any combination of, or all of a long term storage system, such as a hard drive; a short term storage system, such as random access memory; a removable storage system, such as a floppy drive or a removable drive; and/or flash memory. Memory system 706 may include one or more machine-readable mediums that may store a variety of different types of information. The term machine-readable medium is used to refer to any non-transient medium capable carrying information that is readable by a machine. One example of a machine-readable medium is a non-transient computer-readable medium. Another example of a machine-readable medium is paper having holes that are detected that trigger different mechanical, electrical, and/or logic responses. In an embodiment of computer system 700 that is used as the promotional offers server, memory system 706 may include software for communicating with the purchase terminal, store, and/or promotional offers account system, which may include machine instructions for receiving exchange request from the purchase terminal, querying the promotional offers account system for verification, transmitting exchange/payment confirmation to the store and/or purchase terminal, and/or transmitting results of the exchange to the purchase terminal. The memory system 706 may include software for the promotional offers server to verify exchange requests, convert promotional offers and/or currencies, analyze exchange/purchase data of the user, etc. In an embodiment of computer system 700 that is used as a terminal in a store, website of a store, and/or a server of an online store, memory system 706 may store software for processing purchases and orders, tracking inventory, tracking sales and transactions, updating sales and inventory information as transactions are performed, and/or transmitting confirmation messages to the promotional offers server and/or purchase terminal. In an embodiment of computer system 700 that is used as the promotional offers account system, the memory system 706 may store software for storing and managing user account and promotional offers account, managing databases, searching, authentication, transmitting promotional offers account information, etc. In an embodiment of computer system 700 that is used as the promotional offers server, memory system 706 may store the request receiving module 241, query module 242, conversion module 243, verification module 244, transaction module 245, exchange mode module 246, purchase restriction module 247, analysis module 248, price adjustment module 249, and communications module 250, software for implementing steps S508, S510, S512, S513, S514, S515, S516, S518, S519, S520, S522 (FIGS. 5A and 5B), and S602-S616 (FIG. 6). In an embodiment of computer system 700 that is used as the server of an online store, website of a store, and/or a terminal in a store, memory system 706 may include the order processing module 214, sales database 215, price management module 216, and communications module 217, software for implementing steps S504, S520, and S522 (FIGS. 5A and 5B). In an embodiment of computer system 700 that is used as the promotional offers account system, memory system 706 may include the promotional offers programs 221, promotional offers database 222, user database 223, account management module 224, data extraction module 225, authentication module 226, and communications module 227, software for implementing steps S506, SS510, S514, S518, and S519 (FIGS. 5A and 5B).

Processor system 708 may include any one of, some of, any combination of, or all of multiple parallel processors, a single processor, a system of processors having one or more central processors and/or one or more specialized processors dedicated to specific tasks. In an embodiment of computer system 700 that is used as the promotional offers server, processor system 708 may implement the machine instructions stored in memory system 706, such as the request receiving module 241, query module 242, conversion module 243, verification module 244, transaction module 245, exchange mode module 246, purchase restriction module 247, analysis module 248, price adjustment module 249, and communications module 250, software for implementing steps S508, S510, S512, S513, S514, S515, S516, S518, S519, S520, S522 (FIGS. 5A and 5B), and S602-S616 (FIG. 6). In an embodiment of computer system 700 that is used as the server of an online store, website of a store, and/or a terminal in a store, processor system 708 may implement machine instructions stored in memory system 706, such as software for managing information about product and prices/corresponding promotional offers, processing purchases/orders, tracking inventory, tracking sales and transactions, updating sales and inventory information as transactions are performed, and/or sending order information to the promotional offers server, the purchase terminal and/or the promotional offers account system. In an embodiment of computer system 700 that is used as the server of an online store, website of a store, and/or a terminal in a store, processor system 708 may implement the machine instruction stored in memory system 706 such as the order processing module 214, sales database 215, price management module 216, and communications module 217, software for implementing steps S504, S520, and S522 (FIGS. 5A and 5B). In an embodiment of computer system 700 that is used as the promotional offers account system, processor system 708 may implement the machine instruction stored in memory system 706 such as the promotional offers programs 221, promotional offers database 222, user database 223, account management module 224, data extraction module 225, authentication module 226, and communications module 227, software for implementing steps S506, SS510, S514, S518, and S519 (FIGS. 5A and 5B).

Communications system 712 communicatively links output system 702, input system 704, memory system 706, processor system 708, and/or input/output system to each other. Communications system 712 may include any one of, some of, any combination of, or all of electrical cables, fiber optic cables, and/or means of sending signals through air or water (e.g. wireless communications), for example. Some examples of means of sending signals through air and/or water include systems for transmitting electromagnetic waves such as infrared and/or radio waves and/or systems for sending sound waves.

Input/output system 714 may include devices that have the dual function as input and output devices. For example, input/output system 714 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 714 is optional, and may be used in addition to or in place of output system 702 and/or input system 704.

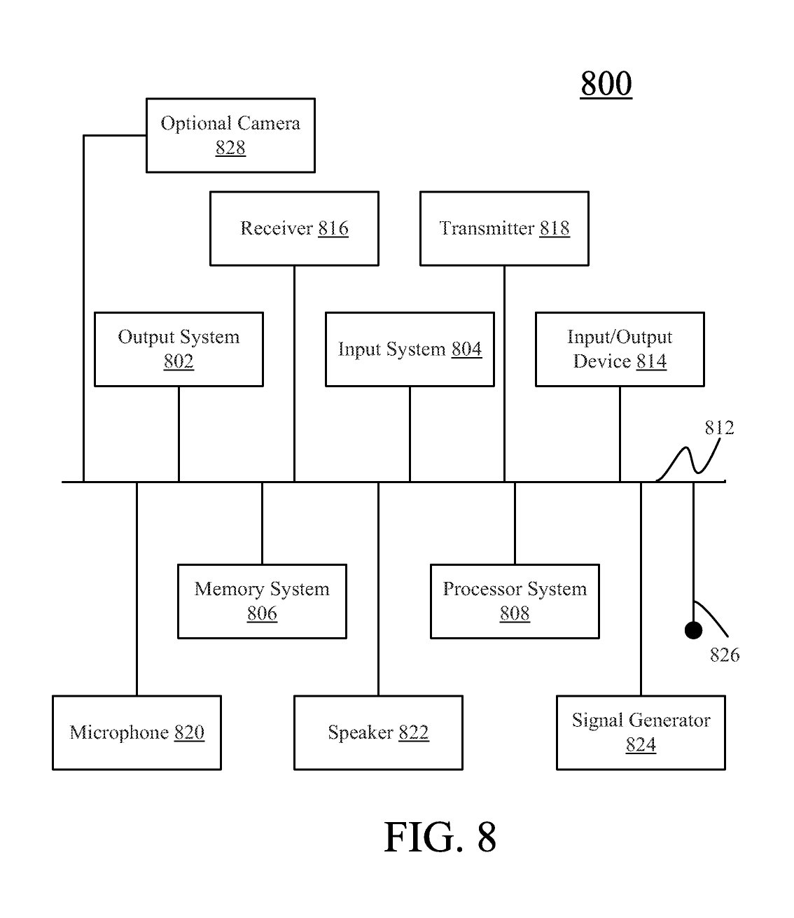

FIG. 8 shows a block diagram of an embodiment of the purchase terminal 800 used in the exchange system. The purchase terminal 800 may be any of the purchase terminals 130, 230, 330, and 533. In other embodiments, the purchase terminal 800 may include additional components and/or may not include all of the components listed above.

Output system 802, input system 804, memory system 806, processor system 808, communications system 812, input/output system 814 were discussed in conjunction with output system 702, input system 704, memory system 706, processor system 708, communications system 712, and input/output system 714 of FIG. 7.

However, memory system 806 of the purchase terminal stores the web browser 231, mobile app 232, confirmation module 233, and communications module 234. Memory system 806 of the purchase terminal also includes machine instructions for steps S502, S504, S506, S508, S513, S514, S515, S516, and S522 (FIGS. 5A and 5B). Processor system 808 of the purchase terminal implements the machine instructions of the web browser 231, mobile app 232, confirmation module 233, and communications module 234. Processor system 808 of the purchase terminal implements the machine instructions for steps S502, S504, S506, S508, S513, S514, S515, S516, and S522 (FIGS. 5A and 5B).

Receiver 816 processes the signals received from the promotional offers server, store, and/or promotional offers account system. Transmitter 818 prepares signals for transmission to the promotional offers server, store, and/or promotional offers account system. Microphone 820 receives audio signals from the store or promotional offers server in an embodiment (in addition to being used for carrying on a conversation during a phone call). Microphone 820 may be a mini-microphone to be installed in a mobile device. Speaker 822 produces audio signals, which may be sent to the store or promotional offers server in an embodiment (in addition to being used for carrying on a conversation during a phone call). Signal generator 824 produces signals, which may be converted into electromagnetic signals and/or audio signals. Antenna 826 may send and receive electromagnetic signal. Antenna 826 may be an electromagnetic sensor. Optional camera 828 is a camera that may come with the purchase terminal.

### Alternatives and Extensions

Each embodiment disclosed herein may be used or otherwise combined with any of the other embodiments disclosed. Any element of any embodiment may be used in any embodiment.

In an example, the purchase terminal is a mobile device that is connected to the promotional offers server via a mobile application program or a mobile web browser. The promotional offers account system is external to the promotional offers server, while the promotional offers server is connected to the promotional offers account system and allows the purchase terminal to enter the user's login information (e.g., user ID and password) into the user account in the promotional offers account system. The promotional offers account system is linked to one or more merchant systems that provide promotional offers programs, and the promotional offers account system retrieves information about the promotional offers of the users in the programs. The promotional offers server collects the retrieval information of the user's promotional offers and may convert to internal settlement currency values or values in a currency in circulation. The promotional offers server sends the promotional offers information and conversion results to the purchase terminal to be displays on the purchase terminal.

The user uses the purchase terminal to browse a mobile app store to select electronic product. The user then uses the purchase terminal to select one or more of the promotional offers programs to pay for the selected product. The promotional offers server receives the request and verifies if the selected promotional offers are sufficient to be exchange for the selected product and if the online payment account of the user has sufficient amount of funds to pay for the balance due after deduction of the selected promotional offers. If sufficient, the promotional offers server sends a message to the promotional offers account system that sends requests to the corresponding merchant systems to deduct the corresponding promotional offers in the user account in the promotional programs. The corresponding merchant systems send confirmation of deductions to the promotional offers account system that sends the confirmation to the promotional offers server. If the promotional offers in the programs are insufficient, the promotional offers server charges the online payment accounts of the user via the promotional offers account system. Then the promotional offers server sends a confirmation message to the mobile app store that the promotional offers are deducted and/or online payment has been made. The mobile app store then sends a successful transaction message to the promotional offers server, and the promotional offers server sends the successful transaction message to the device or email address designated by the user. The successful transaction message may include a download link/code of the purchased electronic product. The user may start downloading by clicking the link received on the purchase terminal or in the e-mail received. Alternatively, the successful transaction message may include the electronic product, which is directly downloaded to the purchase terminal. If the selected product include non-electronic product from a physical store, the successful transaction message may include a voucher or token for the user to pick up the product. Alternatively, the user may request the store to deliver the product to a physical address.

Promotion offers exchange system in at least one embodiment may have other various embodiments, without departure from spirit and essence of the present specification, a person skilled in the art may make various corresponding modifications and variations according to the present specification. However, these modifications and variations should fall within the protective scope of the appended claims of the present specification.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method, comprising:
receiving, at a server from a purchase terminal, an exchange request including at least a request to exchange a plurality of promotional offers of a user for a product, the product being provided by a provider, the server having a processor system including at least one processor, a memory system storing one or more machine instructions on one or more non-transitory computer readable media;
retrieving, by the server from an account system, information about the plurality of promotional offers;
verifying, by the server, the exchange request, wherein the exchange request is approved if the plurality of promotional offers are sufficient to pay for the product, wherein the exchange request is rejected if the plurality of promotional offers are insufficient to pay for the product;
in response to the approval of the exchange request, sending, from the server to the account system, a request to deduct promotional offers that are required to pay for the product, and
sending, from the server to the provider, a request to provide the product to the user.

2. The method of claim 1, further comprising,
in response to the rejection of the exchange request, sending, from the server to the purchase terminal, a notice including at least information about insufficient promotional offers to be exchanged for the product.

3. The method of claim 2, further comprising,
determining, by the server, a balance due after deduction of the plurality of promotional offers; and
sending, from the server to the purchase terminal, an option of at least one payment method to pay for the balance due.

4. The method of claim 1, further comprising,
in response to the rejection of the exchange request,
determining, by the server, a balance due after deduction of the plurality of promotional offers;
retrieving, by the server from the account system, information about at least a payment account of the user, the information including at least a remaining balance in the payment account of the user;
comparing, by the server, the remaining balance in the payment account of the user and the balance due after deduction of the plurality of promotional offers; and
if the remaining balance is greater than or equal to the balance due, sending, from the server to the purchase terminal, a request for a confirmation to approve deduction of the plurality of promotional offers of the user and deduction of the balance due in the payment account;
receiving, at the server from the purchase terminal, the confirmation;
sending, from the server to the account system, a request to deduct the plurality of promotional offers of the user and to deduct the balance due in the payment account; and
sending, from the server to the provider, a request to provide the product to the user.

5. The method of claim 1, the step of verifying, by the server, the exchange request further comprising
converting, by the server, the plurality of promotional offers to a value, and
comparing the converted value of the plurality of promotional offers to a value of the product.

6. The method of claim 5, wherein
the converted value of the plurality of promotional offers is in a currency in circulation.

7. The method of claim 5, wherein
the converted value of the plurality of promotional offers is in an internal currency.

8. The method of claim 7, further comprising
converting, by the server, a price of the product in a currency in circulation to a value in the internal currency.

9. The method of claim 5, wherein
the plurality of promotional offers are associated with a plurality of promotional programs that include a plurality of conversion rules, wherein the converted value of the plurality of promotional offers is a sum of values that are converted based on the plurality of conversion rules.

10. The method of claim 1, further comprising
retrieving, by the server from the provider, information about the product.

11. The method of claim 10, wherein
the information about the product includes at least an amount of at least one type of promotional offer that is required to pay for the product.

12. The method of claim 11, the step of verifying, by the server, the exchange request further comprising
retrieving an amount of the promotional offers retrieved from the account system; and
comparing the amount of the promotional offers retrieved from the account system and the amount of the at least one type of promotional offers that is required to pay for the product, wherein the exchange request is approved if the amount of the promotional offers retrieved from the account system is greater than or equal to the amount of the at least one type of promotional offers that is required to pay for the product, wherein the exchange request is rejected if the amount of the promotional offers retrieved from the account system is fewer than the amount of the at least one type of promotional offers that is required to pay for the product.

13. The method of claim 1, wherein
the provider includes at least an online store.

14. The method of claim 1, wherein
the provider includes at least a mobile application store.

15. The method of claim 1, wherein
the provider includes at least a website of a store.

16. The method of claim 1, wherein
the purchase terminal is a mobile device, the mobile device including at least an an application including calls to an application program interface, wherein the product includes at least an application that is downloaded to the purchase terminal via the calls to the application program interface.

17. The method of claim 1, further comprising
receiving, at the server from the provider, a confirmation that the product is provided, and
sending, from the server to the purchase terminal, the confirmation.

18. The method of claim 17, wherein
the product is an electronic product, and the confirmation includes at least a download link, which when activated, causes the electronic product to be downloaded to the purchase terminal.

19. The method of claim 17, further comprising
electronically transmitting the product from the provider to the purchase terminal, the product being the electronic product.

20. The method of claim 17, wherein
the confirmation includes at least a notice that the product is delivered to the user.

21. The method of claim 17, further comprising
sending, from the server to the purchase terminal, an electronic token for picking up the product from the provider.

22. The method of claim 1, wherein
the account system is within the server.

23. The method of claim 1, wherein
the account system is outside of the server, the account system being communicatively connected to the server.

24. The method of claim 1, wherein
the plurality of promotional offers are associated with a plurality of promotional programs, the method further comprising
after the step of sending, from the server to the account system, a request to deduct promotional offers that are required to pay for the product, sending, from the account system to the plurality of promotional programs, a plurality of requests to deduct the plurality of promotional offers in corresponding promotional programs.

25. The method of claim 1, further comprising
setting a restriction, by the server, on at least one type of product, wherein the restriction, when activated, causes the server to reject an exchange request for exchanging at least one type of promotional offer for the at least one type of product.

26. The method of claim 1, further comprising
setting a restriction, by the server, on at least one type of product, wherein the restriction, when activated, causes the server to reject an exchange request for exchanging the plurality of promotional offers for a preset number of the at least one type of product.

27. The method of claim 1, further comprising,
analyzing, by the server, information about the user;
predicting, by the server based on the information about the user, a product that is interesting to the user;
adjusting, by the server, a value of the product that is predicted to be interesting to the user, the value to which the product is adjusted to being at least as much as an amount of a predetermined plurality of promotional offers for the product that is predicted to be interesting to the user.

28. The method of claim 1, further comprising
determining, by the server, a plurality of combinations of promotional offers, each of the plurality of combinations of promotional offers being sufficient to pay for the product;
sending, from the server to the purchase terminal, a list of the plurality of combinations of promotional offers;
receiving, at the server from the purchase terminal, a selection of one combination from the plurality of combinations of promotional offers; and
sending, from the server to the account system, a request to deduct the selected one combination of promotional offers.

29. A method, comprising:
receiving, at a server from a purchase terminal, an exchange request for exchanging a plurality of promotional offers of a user for a product, the product being provided by at least a provider, the server having a processor system including at least one processor, a memory system storing one or more machine instructions on one or more non-transitory computer readable media, and a network interface;
retrieving, by the server from the account system, information about the plurality of promotional offers and a remaining balance in the at least one payment account;
verifying, by the server, the exchange request, wherein the exchange request is approved if the plurality of promotional offers is sufficient to pay for the product and if a sum of the plurality of promotional offers and the remaining balance are sufficient to pay for the product, wherein the exchange request is rejected if the sum of the plurality of promotional offers and the remaining balance is insufficient to pay for the product;
in response to the approval of the exchange request, sending, from the server to the account system, a request to deduct an amount of the plurality of promotional offers;
determining, by the server, a balance due after deduction of the amount of the plurality of promotional offers,
if the balance due is greater than zero, sending, from the server to the account system, a request to deduct the balance due in the at least one payment account; and
sending, from the server to the provider, a request to provide the product to the user.

30. A server, comprising
a processor system having at least a processor, a network interface, a memory system storing one or more machine instructions on one or more non-transitory computer readable media; and
wherein the one or more machine instructions, when implemented, cause the processor system of the server to implement a method including at least:
receiving, at the server from a purchase terminal, an exchange request for exchanging a plurality of promotional offers of a user for a product, the product being provided by a provider;
retrieving, by the server from an account system, information about the plurality of promotional offers;
verifying, by the server, the exchange request, wherein the exchange request is approved if the plurality of promotional offers are sufficient to pay for the product, wherein the exchange request is rejected if the plurality of promotional offers are insufficient to pay for the product;
in response to the approval of the exchange request, sending, from the server to the account system, a request to deduct promotional offers that are required to pay for the product, and
sending, from the server to the provider, a request to provide the product to the user.

31. The system of claim 30, the method implemented by the one or more machine instructions further including
converting, by the server, the plurality of promotional offers to a value, and
comparing the value of the plurality of promotional offers to a value of the product.

32. The system of claim 30, the method implemented by the one or more machine instructions further including
in response to the rejection of the exchange request, determining, by the server, a balance due after deducting the plurality of promotional offers; and
sending, from the server to the purchase terminal, an option of at least one payment method to pay for the balance due.

33. The system of claim 30, the method implemented by the one or more machine instructions further including
in response to the rejection of the exchange request,
determining, by the server, a balance due after deducting plurality of promotional offers;
retrieving, by the server from the account system, information about at least a payment account of the user, the information including at least remaining balance in the payment account of the user;
comparing, by the server, the remaining balance in the payment account of the user and the balance due after the deducting of the plurality of promotional offers; and
if the remaining balance is greater than or equal to the balance due, sending, from the server to the purchase terminal, a request for a confirmation to approve the deducting of the plurality of promotional offers of the user and to approve deducting the balance due from the payment account;
receiving, at the server from the purchase terminal, the confirmation;
sending, from the server to the account system, a request to deduct the plurality of promotional offers of the user and to deduct the balance due in the payment account; and
sending, from the server to the provider, a request to provide the product to the user.

34. The system of claim 30, the method implemented by the one or more machine instructions further including
retrieving, by the server from the provider, information about the product, the information including at least an amount of at least one type of promotional offer that is required to pay for the product; and
comparing an amount of the plurality of promotional offers retrieved from the account system and the amount of the at least one type of promotional offer that is required to pay for the product, wherein the exchange request is approved if the amount of the plurality of promotional offers retrieved from the account system is greater than or equal to the amount of the at least one type of promotional offers that is required to pay for the product, wherein the exchange request is rejected if the amount of the plurality of promotional offers retrieved from the account system is fewer than the amount of the at least one type of promotional offers that is required to pay for the product.

35. The system of claim 30, the method implemented by the one or more machine instructions further including
receiving, at the server from the provider, a confirmation that the product is provided, and
sending, from the server to the purchase terminal, the confirmation.

36. The system of claim 30, the method implemented by the one or more machine instructions further including
setting a restriction, by the server, on at least one type of product, wherein the restriction, when activated, causes the server to reject an exchange request for exchanging at least one type of promotional offer for the at least one type of product.

37. The system of claim 30, the method implemented by the one or more machine instructions further including
analyzing, by the server, information about the user;
predicting, by the server based on the information about the user, a product that is interesting to the user;
adjusting, by the server, a value of the product that is interesting to the user, the value of the product including at least an amount of the plurality of promotional offers that is required to exchange for the product.

38. The system of claim 30, the method implemented by the one or more machine instructions further including
determining, by the server, a plurality of combinations of promotional offers, each of the plurality of combinations of promotional offers being sufficient to pay for the product;
sending, from the server to the purchase terminal, a list of the plurality of combinations of promotional offers;
receiving, at the server from the purchase terminal, a selection of one combination from the plurality of combinations of promotional offers; and
sending, from the server to the account system, a request to deduct the one combination that was selected from the plurality of combinations of the promotional offers.

39. A purchase terminal, comprising:
a processor system having at least a processor, a network interface, a memory system storing one or more machine instructions on one or more non-transitory computer readable media; and
wherein the one or more machine instructions, when implemented, cause the processor system of the purchase terminal to implement a method including at least:
selecting, by the purchase terminal, a product from a provider;
sending, from the purchase terminal to a server, an exchange request including at least a request to exchange a plurality of promotional offers of a user for the product selected by the purchase terminal, wherein the exchange request is approved or rejected by the server; and
in response to the rejection of the exchange request, receiving, at the purchase terminal from the server, a notice including at least information about insufficient promotional offers to be exchanged for the product, or
in response to the approval of the exchange request, receiving, at the purchase terminal from the server or the provider, order information about the product.

40. An account system, comprising:
a processor system having at least a processor, a network interface, a memory system storing one or more machine instructions on one or more non-transitory computer readable media; and
wherein the one or more machine instructions, when implemented, cause the processor system of the account system to implement a method including at least:
receiving, at the account system from a server, a request for information about a plurality of promotional offers and at least one online payment account of a user, the plurality of promotional offers being associated with at least one promotional program;
retrieving, by the account system from the at least one promotional program and the at least one online payment account, information about the plurality of promotional offers and remaining balance in the at least one online payment account, respectively; and
sending, from the account system to the server, the information about the plurality of promotional offers and remaining balance in the at least one online payment account.
